(19) United States
(12) Patent Application Publication
(10) Pub. No.: US 2026/0120017 A1
(43) Pub. Date: Apr. 30, 2026

(54) MANUFACTURING PLANNING SYSTEM, MANUFACTURING PLANNING METHOD, PROGRAM

(71) Applicant: Panasonic intellectual Property Management Co., Ltd., Osaka (JP)

(72) Inventors: Yoshiyuki OKIMOTO, Nara (JP); Yoshihiro Nakaminami, Osaka (JP); Akira Minegishi, Osaka (JP); Yuta Shimazaki, Osaka (JP)

(21) Appl. No.: 19/431,355

(22) Filed: Dec. 23, 2025

Related U.S. Application Data
(63) Continuation of application No. PCT/JP2024/016280, filed on Apr. 25, 2024.

(30) Foreign Application Priority Data
Jun. 28, 2023 (JP) 2023-106389

(51) Int. Cl. G06Q 10/0631; G05B 19/418; G06Q 10/087; G06Q 50/04

(52) U.S. Cl. CPC G06Q 10/06312; G05B 19/41865; G06Q 10/0877; G06Q 50/04

(57) ABSTRACT

The manufacturing panning system includes an arithmetic circuit accessible to data on a manufacturing plan for manufacturing a plurality of different products by a manufacturing facility performing a plurality of processes. The arithmetic circuit is configured to: for a shortage product among the plurality of different products of which a predicted quantity of a finished product by a due date is less than a target quantity, output, a first modification proposal to change the manufacturing plan so as to increase a production quantity of the shortage product in a first process performed first among the plurality of processes when remaining time until the due date is equal to or longer than manufacturing lead time; and output, a second modification proposal to change the manufacturing plan so as to prioritize manufacturing the shortage product in a second process performed after the first process among the plurality of processes.

### CROSS-REFERENCE TO RELATED APPLICATIONS

The present application is a continuation of PCT/JP2024/016280 filed on Apr. 25, 2024, which claims the priority to Japanese Patent Application No. 2023-106389, filed on Jun. 28, 2023, the entire content of which is incorporated herein by reference.

### TECHNICAL FIELD

The present disclosure relates to manufacturing planning systems, manufacturing planning methods, and programs.

### BACKGROUND ART

Patent Document 1 discloses a production management device. In the production management device of Patent Document 1, a master storage unit stores a product master that defines a first period starting from the current day and a second period following the first period, in association with identification information of products. A production plan storage unit stores production plans for the products. When order information including product identification information, a production quantity, a delivery date, and a predetermined data classification is received, a determination unit refers to the product master and determines, according to the data classification indicating the purpose of input of the order information and the update content based on the order information, whether an update of the production plan based on the order information is allowed or not. Specifically, if the delivery date is included in the second period, the determination unit determines that the update of the production plan based on the order information is allowed, and if the delivery date is included in the first period, it determines that the update of the production plan based on the order information is not allowed. A production plan update processing unit updates the production plan stored in the production plan storage unit based on the order information that the determination unit has determined to be allowable for update.

### PRIOR ART DOCUMENTS

### Patent Documents

Patent Document 1: JP 5438211 B

### SUMMARY OF THE INVENTION

### Problems to be Solved by the Invention

In Patent Document 1, when updates to the production plan are received in real time, it is possible to prevent the occurrence of inaccurate plans in advance.

In manufacturing sites, management is increasingly required to reduce product inventory or shorten manufacturing lead time. In the manufacturing sites, production may be delayed due to external factors such as material procurement or internal factors such as equipment failures or defects. However, the shipment of products to customers must be carried out by the respective deadlines (due dates) for each product. Nevertheless, as the manufacturing process becomes more complex, it becomes increasingly difficult to determine whether delays in shipment to customers are likely to occur and, if such delays are anticipated, how to recover from them. The technology described in Patent Document 1 cannot cope with such production delays of products.

The present disclosure provides a manufacturing planning system, a manufacturing planning method, and a program that enable reduction in a shortage quantity of a product at a due date.

### Solutions to the Problems

A manufacturing panning system according to one aspect of the present disclosure includes an arithmetic circuit accessible to data on a manufacturing plan for manufacturing a plurality of different products by a manufacturing facility performing a plurality of processes. The arithmetic circuit is configured to: for a shortage product among the plurality of different products of which a predicted quantity of a finished product by a due date is less than a target quantity, output, a first modification proposal to change the manufacturing plan so as to increase a production quantity of the shortage product in a first process that is performed first among the plurality of processes when remaining time until the due date is equal to or longer than manufacturing lead time; and output, a second modification proposal to change the manufacturing plan so as to prioritize manufacturing the shortage product in a second process that is performed after the first process among the plurality of processes.

A manufacturing panning method according to one aspect of the present disclosure is performed by an arithmetic circuit accessible to data on a manufacturing plan for manufacturing a plurality of different products by a manufacturing facility performing a plurality of processes and includes: for a shortage product that is among the plurality of different products and of which a predicted quantity of a finished product by a due date is less than a target quantity, outputting, a first modification proposal to change the manufacturing plan so as to increase a production quantity of the shortage product in a first process that is performed first among the plurality of processes when remaining time until the due date is equal to or longer than manufacturing lead time; and outputting, a second modification proposal to change the manufacturing plan so as to prioritize manufacturing the shortage product in a second process that is performed after the first process among the plurality of processes.

A program according to one aspect of the present disclosure is a program for enabling the above manufacturing planning method to be performed by the arithmetic circuit.

### Effects of the Invention

Aspects of the present disclosure enables reduction in a shortage quantity of a product at a due date.

### BRIEF DESCRIPTION OF THE DRAWINGS

FIG. 1 is a schematic diagram of a manufacturing system according to one embodiment.

FIG. 2 is a schematic diagram of a manufacturing facility of the manufacturing system of the above embodiment.

FIG. 3 is a block diagram of an information management system of the manufacturing system of the above embodiment.

FIG. 4 is a block diagram of a manufacturing planning system of the manufacturing system of the above embodiment.

FIG. 5 is a graph showing an example of the distribution of manufacturing time of a process for each product.

FIG. 6 is a graph showing an example of the distribution of dwell time between processes for each product.

FIG. 7 is a flowchart illustrating determination of modifications to the manufacturing plan by the manufacturing planning system.

FIG. 8 is a histogram showing the distribution of the predicted quantity of the finished product.

FIG. 9 is a histogram showing an example of the distribution of the difference between the predicted quantity and the target quantity of the finished product.

FIG. 10 is a histogram showing another example of the distribution of the difference between the predicted quantity and the target quantity of the finished product.

FIG. 11 is a histogram showing yet another example of the distribution of the difference between the predicted quantity and the target quantity of the finished product.

FIG. 12 is a flowchart illustrating surplus/shortage determination of the product by the manufacturing planning system.

FIG. 13 is an explanatory diagram of a first modification proposal by the manufacturing planning system of the above embodiment.

FIG. 14 is an explanatory diagram of a first modification proposal by the manufacturing planning system of the above embodiment.

FIG. 15 is an explanatory diagram of a second modification proposal by the manufacturing planning system of the above embodiment.

FIG. 16 is an explanatory diagram of a second modification proposal by the manufacturing planning system of the above embodiment.

FIG. 17 is an explanatory diagram of a second modification proposal by the manufacturing planning system of the above embodiment.

FIG. 18 is a graph showing the difference between the predicted quantity and the target quantity of the product when the first modification proposal is implemented.

FIG. 19 is a graph showing the difference between the predicted quantity and the target quantity of the product when the first modification proposal is not implemented.

FIG. 20 is a graph showing the production quantities of the product when the second modification proposal is implemented and when the second modification proposal is not implemented.

### DETAILED DESCRIPTION

### 1. Embodiments

Hereinafter, embodiments of the present disclosure will be described with reference to the drawings where appropriate. However, the following embodiments are merely examples for explaining the present disclosure, and are not intended to limit the present disclosure to the following content (e.g., shapes, dimensions, arrangement and the like, of components). Positional relationships such as up, down, left, and right are based on the positional relationships shown in the drawings, unless otherwise specified. Each figure described in the following embodiments is a schematic diagram, and the ratios of size and thickness of each component in each figure do not necessarily reflect the actual dimensional ratios. Furthermore, the dimensional ratios of each element are not limited to the ratios shown in the drawings.

In the following description, if it is necessary to distinguish a plurality of components from each other, prefixes, such as, “first”, “second”, or the like are attached to names of such components. However, if these components can be distinguished from each other by reference signs attached to those components, such prefixes, such as, “first”, “second”, or the like, may be omitted in consideration of readability of texts.

Note that, in the following description, if it is necessary to distinguish a plurality of components from each other, suffixes, such as, “−1”, “−2”, or the like are attached to reference signs of such components. if there is no need to distinguish such components from each other, such suffixes, such as, “−1”, “−2”, or the like, may be omitted in consideration of readability of texts.

### 1.1 Configurations

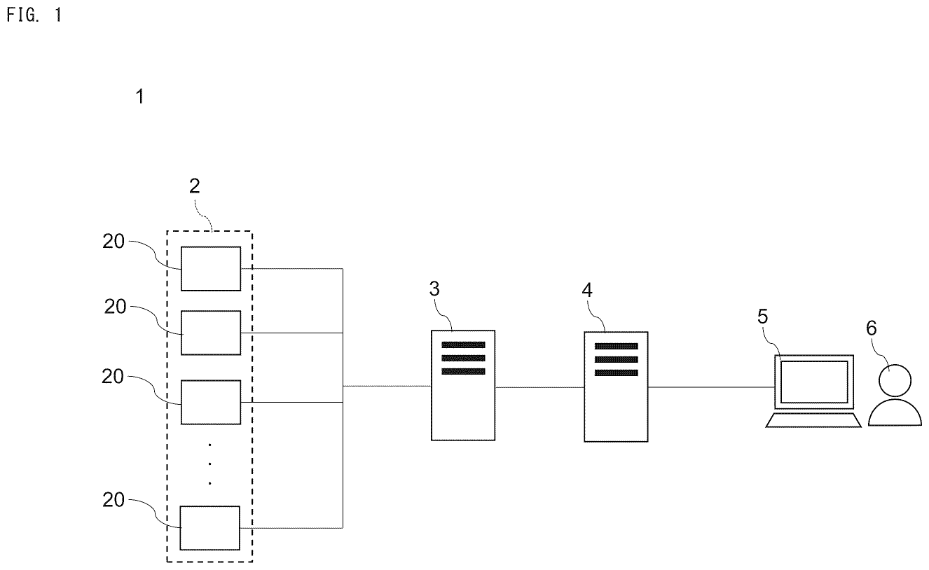

FIG. 1 is a schematic diagram of a manufacturing system 1 according to the present embodiment. The manufacturing system 1 is used for manufacturing a plurality of different products. Each product is manufactured from raw materials through a plurality of processes. The products are not particularly limited, and may include various goods such as food, pharmaceuticals, electrical products, jewelry, furniture, and vehicles. The products may be not only finished products but also components. Examples of finished products include automobiles, while examples of components include core parts of automobiles (such as pistons). The plurality of different products are identified and managed by product-specific identification information. Examples of identification information include product numbers.

The manufacturing system 1 includes a manufacturing facility 2, an information management system 3, a manufacturing planning system 4, and an information terminal 5.

The information terminal 5 is used by a user 6. The information terminal 5 may be realized, for example, by a personal computer (such as a desktop computer or a laptop computer) or a mobile device (such as a smartphone or a tablet terminal). The manufacturing system 1 can present information to the user 6 through the information terminal 5 and, when necessary, request the user 6 to input information.

The manufacturing facility 2 performs a plurality of processes to manufacture products. The manufacturing facility 2 is what is generally referred to as a factory. The manufacturing facility 2 includes apparatuses 20 that perform individual processes. The apparatuses 20 are appropriately selected according to the product. The apparatuses 20 may include manufacturing equipment that enables production using various manufacturing techniques. Examples of such manufacturing techniques include: additive manufacturing technologies, such as material extrusion, vat photopolymerization, material jetting, binder jetting, powder bed fusion, sheet lamination, and directed energy deposition; subtractive manufacturing technologies, such as cutting, grinding, electrical discharge machining, casting, die casting, pressing, forging, and sheet metal processing; formative (forming) manufacturing technologies, such as injection molding and extrusion molding; surface treatment technologies, such as coating, painting, plating, and polishing; heat treatment technologies, such as sintering and cooling; joining technologies, such as ultrasonic welding, heat welding, mechanical joining, and adhesion; and assembly technologies, such as component assembly, micro-transfer (imprinting), and impregnation. The apparatuses 20 may include not only manufacturing equipment but also measuring, inspection, and conveying equipment. Examples of the manufacturing facility 2 include a factory, a store, or a building (either an entire building or a floor thereof).

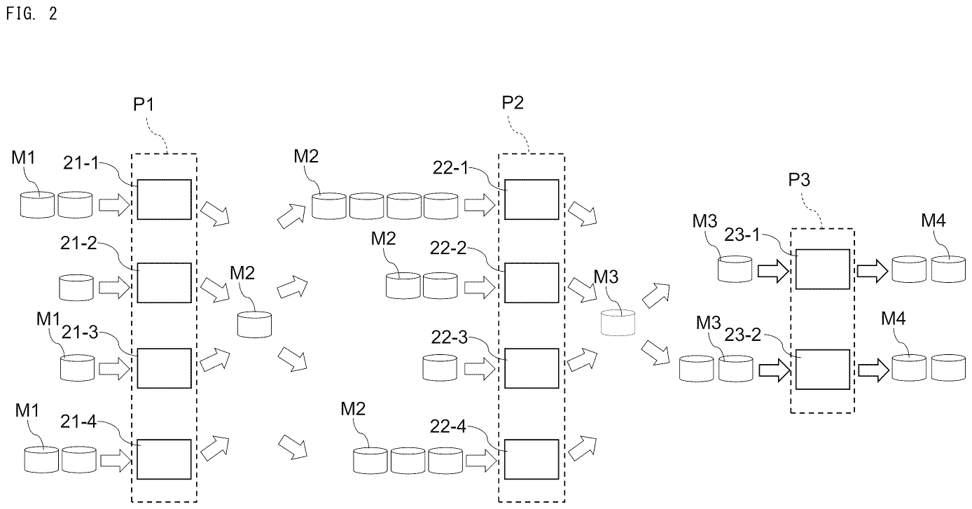

FIG. 2 is a schematic diagram of the manufacturing facility 2. The manufacturing facility 2 manufactures a plurality of different products. In the manufacturing facility 2, a lot production method is employed. Products are manufactured on a lot-by-lot basis. A lot is the smallest unit of a production quantity of a product. The production quantity per lot is appropriately set according to the product and may differ from one product to another.

The manufacturing process for each product includes a plurality of processes P1, P2, and P3. The manufacturing facility 2 includes, as the apparatuses 20, apparatuses 21-1 to 21-4 each performing the process P1, apparatuses 22-1 to 22-4 each performing the process P2, and apparatuses 23-1 and 23-2 each performing the process P3.

The apparatuses 21-1 to 21-4 manufacture a work-in-process product M2 from a raw material M1 of a product. Conditions for manufacturing the work-in-process product M2 from the raw material M1 are appropriately set for each product. The apparatuses 22-1 to 22-4 manufacture a work-in-process product M3 from the work-in-process product M2 of the product. Conditions for manufacturing the work-in-process product M3 from the work-in-process product M2 are appropriately set for each product. The apparatuses 23-1 and 23-2 manufacture a finished product M4 from the work-in-process product M3 of the product. Conditions for manufacturing the finished product M4 from the work-in-process product M3 are appropriately set for each product.

For the first process that is among the plurality of processes and is performed first, an input plan is determined. The input plan indicates a schedule of manufacturing a plurality of different products by one or more first apparatuses performing the first process. In other words, the input plan shows which product lot will be manufactured, on which first apparatus, and when. In the manufacturing facility 2, the process P1 corresponds to the first process, and the apparatuses 21-1 to 21-4 correspond to the first apparatuses. The raw material M1 is input into any one of the apparatuses 21-1 to 21-4 according to the input plan.

TABLE 1 below shows an example of an input plan. In TABLE 1, “Quantity” refers to the number of lots of the product of the corresponding product number. For example, at the apparatus 21-1 on 3/10, it means that 100 lots of the product with the product number A will be manufactured.

TABLE 1

| | 3/10 | | 3/11 | | 3/12 | | . . . | |
|---|---|---|---|---|---|---|---|---|
| | | Product | | Product | | Product | | Product |
| Apparatus | Quantity | Number | Quantity | Number | Quantity | Number | Quantity | Number |
| 21-1 | 100 | A | 100 | A | 100 | B | | |
| 21-2 | 100 | B | 100 | B | 100 | B | | |
| 21-3 | 100 | B | 100 | B | 100 | B | | |
| . . . | . . . | . . . | . . . | . . . | . . . | . . . | . . . | . . . |
| 21-N | 100 | XX | 100 | YY | 100 | YY | | |

In a second process that is among the plurality of processes and is performed after the first process, the work-in-process product obtained in the preceding process is added to the queue of any one of the apparatuses for the second process. In the manufacturing facility 2, the processes P2 and P3 correspond to the second processes. The work-in-process product M2 obtained in the process P1, which precedes the process P2, is added to the queue of any one of the apparatuses 22-1 to 22-4 for the process P2. The work-in-process product M3 obtained in the process P2, which precedes the process P3, is added to the queue of any one of the apparatuses 23-1 and 23-2 for process P3.

TABLE 2 below shows an example of the queue of an apparatus. In TABLE 2, “Order” indicates the sequence in which lots of products corresponding to product numbers are to be manufactured. For example, in the apparatus 22-1, one lot of the product with the product number A is manufactured first, and thereafter, one lot of each product is scheduled to be manufactured sequentially in the order of the product number A, the product number A, the product number B, the product number B, the product number B, the product number C, and the product number C.

TABLE 2

| | Order | | | | | | | |
|---|---|---|---|---|---|---|---|---|
| Apparatus | 1 | 2 | 3 | 4 | 5 | 6 | 7 | 8 |
| 22-1 | A | A | A | B | B | B | C | C |
| 22-2 | B | B | B | B | A | A | A | A |
| 22-3 | B | A | A | A | A | A | A | A |
| . . . | . . . | . . . | . . . | . . . | . . . | . . . | . . . | . . . |
| 22-N | XX | XX | XX | YY | YY | YY | XX | XX |
| 23-1 | A | A | A | A | A | B | B | B |
| 23-2 | B | B | A | A | A | A | A | A |
| . . . | . . . | . . . | . . . | . . . | . . . | . . . | . . . | . . . |
| 23-N | XX | YY | XX | YY | YY | YY | YY | XX |

Normally, addition to the queue is performed on a first-in, first-out (FIFO) basis. The apparatus in the second process to which a lot manufactured in the preceding process is assigned may be fixed, or it may be changed depending on the availability of the apparatuses in the second process.

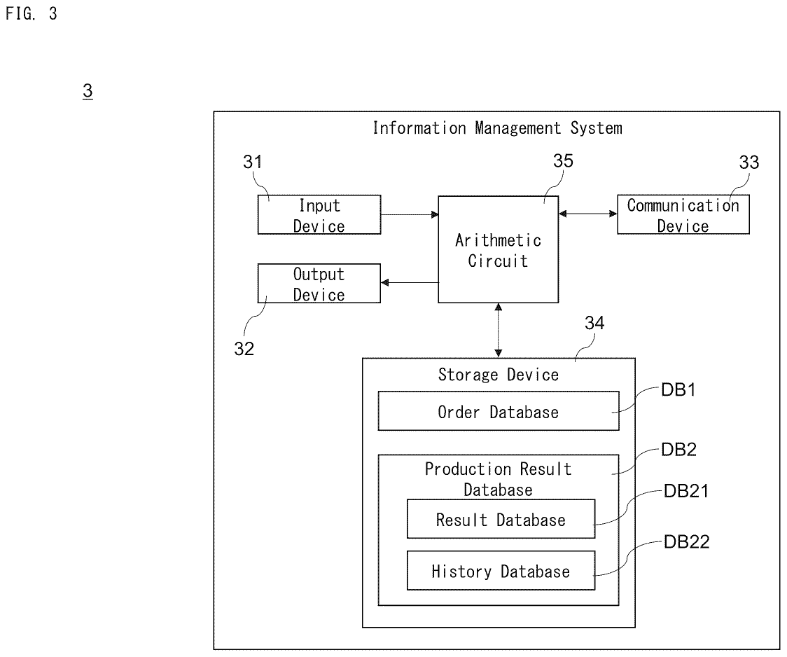

The information management system 3 is configured to manage information on manufacturing of the plurality of different products. FIG. 3 is a block diagram of the information management system 3. The information management system 3 includes an input device 31, an output device 32, a communication device 33, a storage device 34, and an arithmetic circuit 35. The information management system 3 may be implemented by, for example, one or more servers or the like.

The input device 31 includes one or more human-machine interfaces for inputting information. Examples of human-machine interfaces include input interfaces such as a keyboard, pointing devices (e.g., mouse, trackball), touchpad, or positional input devices of a touch panel display. One or more human-machine interfaces of the input device 31 may be built into the information management system 3 or may be external. That is, the input device 31 may include human-machine interfaces of the information management system 3 itself and human-machine interfaces connected to the information management system 3.

The output device 32 includes one or more human-machine interfaces for outputting information. Examples of human-machine interfaces include output interfaces such as a display, speaker, or display devices of a touch panel display. One or more human-machine interfaces of the output device 32 may be built into the information management system 3 or may be external. That is, the output device 32 may include human-machine interfaces of the information management system 3 itself and human-machine interfaces connected to the information management system 3.

The communication device 33 is used for communication via a communication network. The communication device 33 includes one or more communication interfaces. The communication device 33 can be connected to a communication network and has a function to communicate via the communication network. The communication device 33 conforms to a predetermined communication protocol. The predetermined communication protocol may be selected from various known wired and wireless communication standards.

The storage device 34 includes one or more storages (non-transitory storage media). The storage may be, for example, any of a hard disk drive, an optical drive, and a solid-state drive (SSD). The storage may be any of a built-in type, an external type, and a network-attached storage (NAS) type.

Information stored in the storage device 34 includes an order database DB1 and a production result database DB2. FIG. 3 shows a state in which the storage device 34 stores the order database DB1 and the production result database DB2. The order database DB1 and the production result database DB2 do not necessarily have to be constantly stored in the storage device 34; it is sufficient that they are stored in the storage device 34 when required by the arithmetic circuit 35.

The order database DB1 manages information related to requests for manufacturing a plurality of different products by the manufacturing facility 2. The order database DB1 includes target quantity data for a plurality of products to be manufactured in the manufacturing facility 2. The target quantity data includes a due date and a target quantity. The due date is determined based on the delivery date or the deadline of the product. The target quantity represents a target quantity of a product to be manufactured and corresponds to a quantity of a product required by the due date. TABLE 3 below shows an example of the target quantity data.

TABLE 3

| Product Number | Due Date | Target Quantity |
|---|---|---|
| A | 3/31 | 5,000 |
| B | 3/15 | 12,000 |
| . . . | . . . | . . . |
| XX | 3/25 | 9,000 |

The production result database DB2 manages information related to the results of production of a plurality of different products in the manufacturing facility 2. The production result database DB2 includes a result database DB21 and a history database DB22.

The result database DB21 indicates a result of the production quantity per day for each of a plurality of products. TABLE 4 below shows an example of the result database DB21. In TABLE 4, the current date is March 9, and the columns for March 10 and later are blank.

TABLE 4

| Production | Date | | | | | | | |
|---|---|---|---|---|---|---|---|---|
| Number | 3/1 | 3/2 | . . . | 3/9 | 3/10 | . . . | 3/31 | Total |
| A | 98 | 95 | . . . | 99 | | . . . | | 970 |
| B | 350 | 340 | . . . | 360 | | . . . | | 3,405 |
| . . . | . . . | . . . | . . . | . . . | . . . | . . . | . . . | . . . |
| XX | 29− | 300 | . . . | 305 | | . . . | | 2,980 |

The history database DB22 indicates a manufacturing history (past logs). The history database DB22 includes, for each lot, a product number, a manufacturing condition, as well as start time and end time for each process. TABLE 5 below shows an example of the history database DB22. In TABLE 5, “Start” and “End” are used as abbreviations for start time and end time, respectively. In TABLE 5, the current date is March 9, and there are no times recorded for March 10 or later. In TABLE 5, a lot number with end time for the process P3 indicates that the finished product M4 has been obtained—that is, it represents a completed lot. A lot number without end time for the process P3 indicates that the finished product M4 has not yet been obtained—that is, it represents a work-in-process lot. Among the work-in-process lots, a lot number that has no start time for the process P3 but has end time for the process P2 indicates a lot of the work-in-process product M3 waiting for the process P3. Similarly, a lot number that has no start time for the process P2 but has end time for the process P1 indicates a lot of the work-in-process product M2 waiting for the process P2.

TABLE 5

| | | | | Process | Process | Process | Process | Process | Process |
|---|---|---|---|---|---|---|---|---|---|
| Lot | Product | Manufacturing | Manufacturing | P1 | P1 | P2 | P2 | P3 | P3 |
| Number | Number | Condition 1 | Condition 2 | start | end | start | end | start | end |
| 001 | A | x1 | y1 | 3/1 | 3/1 | 3/2 | 3/2 | 3/2 | 3/3 |
| | | | | 9:00 | 23:45 | 2:33 | 18:25 | 19:30 | 5:40 |
| 002 | B | x1 | y2 | 3/1 | 3/1 | 3/2 | 3/2 | 3/2 | 3/3 |
| | | | | 9:15 | 23:05 | 3:10 | 19:31 | 20:40 | 7:12 |
| . . . | . . . | . . . | . . . | . . . | . . . | . . . | . . . | . . . | . . . |
| 099 | M | x9 | y4 | 3/7 | 3/8 | 3/8 | 3/8 | 3/8 | 3/9 |
| | | | | 13:00 | 3:41 | 5:20 | 20:51 | 22:13 | 4:51 |
| 100 | B | x2 | y3 | 3/8 | 3/8 | 3/8 | 3/8 | 3/8 | |
| | | | | 7:00 | 21:30 | 23:01 | 15:30 | 17:21 | |
| 101 | D | x1 | y4 | 3/8 | 3/9 | 3/9 | | | |
| | | | | 22:20 | 13:01 | 14:25 | | | |
| . . . | . . . | . . . | . . . | . . . | . . . | . . . | . . . | . . . | . . . |
| 345 | XX | x3 | y7 | 3/9 | | | | | |
| | | | | 12:00 | | | | | |

The arithmetic circuit 35 is connected to the input device 31, the output device 32, and the communication device 33, and is accessible to the storage device 34. The arithmetic circuit 35 may be implemented, for example, by a computer system. The computer system includes one or more processors (microprocessors) and one or more memories. By executing a program (stored in one or more memories or in the storage device 34), the one or more processors realize various functions of the information management system 3. The program may be pre-recorded in the storage device 34, or may be provided via an electric communication line such as the Internet, or recorded on a non-transitory recording medium such as a memory card.

The arithmetic circuit 35 acquires, for example, via communication through the communication device 33, information related to requests for manufacturing a plurality of different products by the manufacturing facility 2, and updates the order database DB1. The arithmetic circuit 35 acquires, for example, via communication through the communication device 33, information related to the results of production of a plurality of different products in the manufacturing facility 2, and updates the production result database DB2. As one example, the arithmetic circuit 35 can communicate with each of the apparatuses 20 of the manufacturing facility 2 via the communication device 33 and acquire history data as needed.

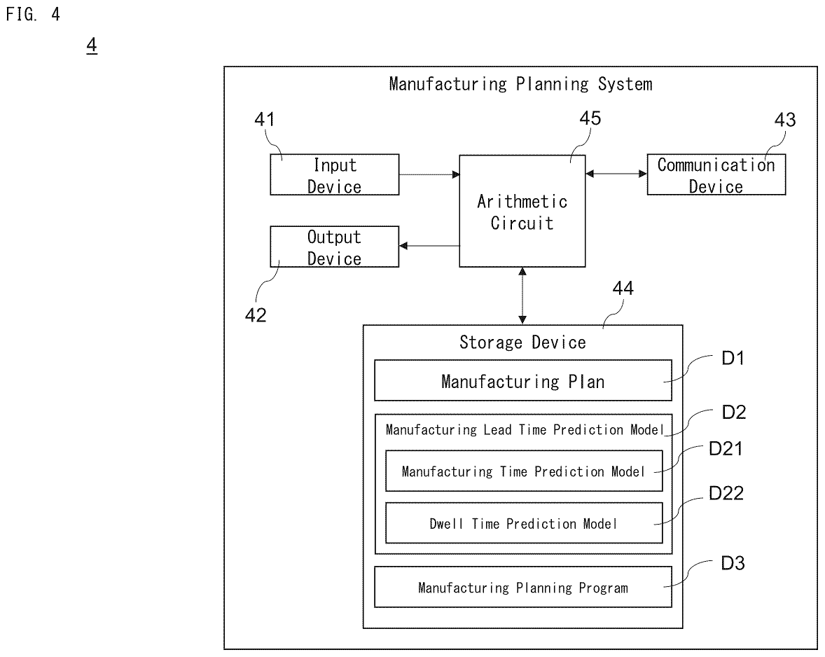

The manufacturing planning system 4 is used for generating and modifying a manufacturing plan for manufacturing a plurality of different products by a plurality of processes performed by the manufacturing facility 2. FIG. 4 is a block diagram of the manufacturing planning system 4. The manufacturing planning system 4 includes an input device 41, an output device 42, a communication device 43, a storage device 44, and an arithmetic circuit 45. The manufacturing planning system 4 may be implemented, for example, by one or more servers or the like. Configurations of the input device 41, the output device 42, the communication device 43, the storage device 44, and the arithmetic circuit 45 are similar to those of the input device 31, the output device 32, the communication device 33, the storage device 34, and the arithmetic circuit 35, respectively.

Information stored in the storage device 44 includes a manufacturing plan D1, a manufacturing lead time prediction model D2, and a manufacturing planning program D3.

The manufacturing plan D1 includes an input plan (see TABLE 1) for the first process that is among the plurality of processes and is performed first, and queues (see TABLE 2) of the apparatuses for the second process that is among the plurality of processes and is performed after the first process.

The manufacturing lead time prediction model D2 is a program for determining the manufacturing lead time of each of a plurality of different products. The manufacturing of the plurality of different products includes a plurality of processes. The manufacturing lead time is obtained as the sum of periods of the manufacturing time for the respective processes and periods of the dwell time between each pair of the processes. The dwell time is time elapsed from the completion of a preceding process until the start of a subsequent process, and corresponds to the time difference between the end time of the preceding process and the start time of the next process. Accordingly, the manufacturing lead time prediction model D2 includes a manufacturing time prediction model D21 for obtaining the manufacturing time for each of the plurality of processes, and a dwell time prediction model D22 for obtaining the dwell time between each pair of the plurality of processes.

In the manufacturing facility 2, a plurality of different products are manufactured through processes P1, P2, and P3. Accordingly, the manufacturing lead time prediction model D2 includes three manufacturing time prediction models D21-1, D21-2, and D21-3, which obtain periods of the manufacturing time for the processes P1, P2, and P3, respectively, and two dwell time prediction models D22-1 and D22-2, which obtain periods of the dwell time between the processes P1 and P2, and between the processes P2 and P3, respectively.

The manufacturing time prediction model D21 outputs the manufacturing time of the corresponding process in response to input of information related to the product. In the present embodiment, the manufacturing time prediction model D21 is a statistical model. The manufacturing time prediction model D21 may be constructed using the history database DB22 in the production result database DB2. As shown in TABLE 6 below, the manufacturing time for each process can be extracted from the history database DB22 for each lot number of each product. The manufacturing time is time from the start time of the process to the end time of the process.

TABLE 6

| | | | | Manufacturing | Manufacturing | Manufacturing |
|---|---|---|---|---|---|---|
| Lot | Production | Manufacturing | Manufacturing | Time of | Time of | Time of |
| Number | Number | Condition 1 | Condition 2 | Process P1 | Process P2 | Process P3 |
| 001 | A | x1 | y1 | 14:45 | 15:52 | 10:10 |
| 002 | B | x1 | y2 | 13:50 | 16:21 | 10:32 |
| . . . | . . . | . . . | . . . | . . . | . . . | . . . |
| 099 | M | x9 | y4 | 14:41 | 15:31 | 9:38 |

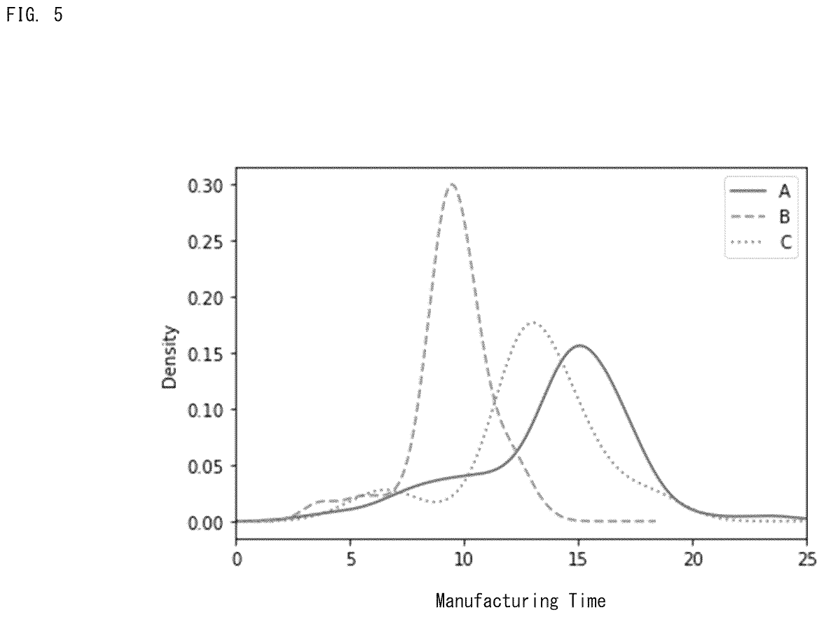

Even for products with the same product number, the manufacturing time varies from lot to lot. Therefore, for a plurality of different products, a distribution of manufacturing time of a process can be obtained. FIG. 5 is an example graph showing the distribution of manufacturing time of a process for each product. FIG. 5 shows distributions of manufacturing time for product numbers A, B, and C with respect to the process P1. Although this is merely an example, FIG. 5 suggests that the distribution of manufacturing time may be assumed to follow a normal distribution. Accordingly, if the manufacturing time is denoted by “y”, the manufacturing time prediction model D21 can be expressed by the following equation (1).

$$\begin{matrix}[ MATHEMATICAL FORMULA 1 ] & \\ y \sim N ( μ , σ ) & ( 1 )\end{matrix}$$

“N (μ, σ)” represents a normal distribution with mean “μ” and standard deviation “σ.” Let “X” be the explanatory variable that serves as a factor altering the distribution of the manufacturing time. The explanatory variable “X” may include the product number, the manufacturing condition 1, and the manufacturing condition 2. In this case, “μ” is expressed by equation (2), and “σ” is expressed by equation (3). “W_{μ}” in equation (2) is a weight coefficient multiplied by the explanatory variable “X”, and “W_{σ}” in equation (3) is a weight coefficient multiplied by the explanatory variable “X.”

$$\begin{matrix}[ MATHEMATICAL FORMULA 2 ] & \\ μ = X \cdot {W}_{μ} & ( 2 )\end{matrix}$$

$$σ = X \cdot {W}_{σ} \qquad ( 3 )$$

As shown in TABLE 6, the explanatory variable “X” and the manufacturing time “y” can be obtained from the history database DB22. Therefore, “W_{μ}” and “W_{σ}” for each process can be determined. For example, “W_{μ}” and “W_{σ}” can be obtained by performing Bayesian estimation using a Markov chain Monte Carlo method (MCMC). In this manner, the manufacturing time prediction model D21 can be constructed for each process.

The manufacturing time prediction model D21 provides the distribution of the manufacturing time with respect to the explanatory variable “X”. By using multiple random numbers, multiple predicted values following the distribution of the manufacturing time corresponding to the explanatory variable “X” can be obtained. The number of predicted values may be, for example, approximately 3000. The manufacturing time may be determined based on a representative value of these multiple predicted values. The representative value may be appropriately selected from the mean, mode, median, or the like.

The dwell time prediction model D22 outputs the dwell time between the corresponding processes in response to input of information related to a product. In the present embodiment, the dwell time prediction model D22 is a statistical model. The dwell time prediction model D22 may be constructed using the history database DB22 in the production result database DB2. As shown in TABLE 7 below, dwell time between processes for each lot number of each product can be extracted from the history database DB22. The dwell time is time from the end time of the previous process to the start time of the next process.

TABLE 7

| Lot | Production | Manufacturing | Manufacturing | Dwell Time between | Dwell Time between |
|---|---|---|---|---|---|
| Number | Number | Condition 1 | Condition 2 | Processes P1-P2 | Processes P2-P3 |
| 001 | A | x1 | y1 | 2:48 | 1:05 |
| 002 | B | x1 | y2 | 4:05 | 1:09 |
| . . . | . . . | . . . | . . . | . . . | . . . |
| 099 | M | x9 | y4 | 1:39 | 1:22 |

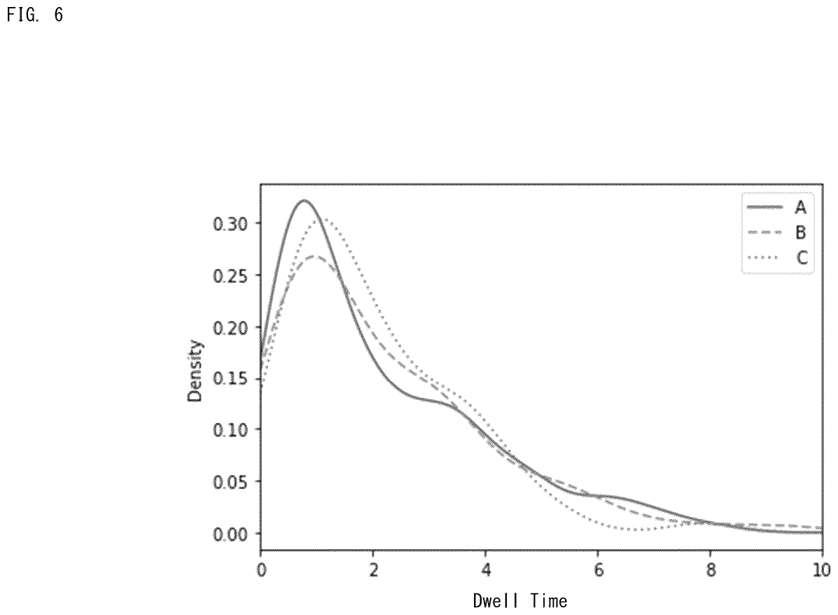

Even for products having the same product number, the manufacturing time of the process differs for each lot. Therefore, for a plurality of different products, a distributions of the manufacturing time of the process can be obtained. FIG. 6 is a graph illustrating an example of the distribution of the manufacturing time of the process for each product. FIG. 6 shows, for the processes between P1 and P2, the distributions of the dwell time for product numbers A, B, and C. Although this is merely an example, FIG. 6 suggests that a gamma distribution may be assumed as the distribution of the dwell time. Accordingly, when the dwell time is denoted as “y”, the dwell time prediction model D22 can be expressed by equation (4).

$$\begin{matrix}[ MATHEMATICAL FORMULA 3 ] & \\ y \sim Ga ( α , β ) & ( 4 )\end{matrix}$$

“Ga (α, β)” represents a gamma distribution with shape parameter “α” and scale parameter “β”. Let “X” be the explanatory variable that serves as a factor altering the distribution of the dwell time. The explanatory variable “X” may include the product number, the manufacturing condition 1, and the manufacturing condition 2. In this case, “α” is expressed by equation (5), and “β” is expressed by equation (6). “W_{α}” in equation (5) is a weight coefficient multiplied by the explanatory variable “X”, and “W_{β}” in equation (6) is a weight coefficient multiplied by the explanatory variable “X”.

$$\begin{matrix}[ MATHEMATICAL FORMULA 4 ] & \\ α = X \cdot {W}_{α} & ( 5 )\end{matrix}$$

$$β = X \cdot {W}_{β} \qquad ( 6 )$$

As shown in TABLE 7, the explanatory variable “X” and the manufacturing time “y” can be obtained from the history database DB22. Therefore, “W_{α}” and “W_{β}” can be determined for each adjacent pair of processes. For example, “W_{α}” and “W_{β}” can be obtained by performing Bayesian estimation using a Markov chain Monte Carlo method (MCMC). In this manner, the dwell time prediction model D22 can be constructed for each adjacent pair of processes.

The dwell time prediction model D22 provides the distribution of the dwell time with respect to the explanatory variable “X”. By using multiple random numbers, multiple predicted values following the distribution of the dwell time corresponding to the explanatory variable “X” can be obtained. The number of predicted values may be, for example, approximately 3000. The dwell time may be determined based on a representative value of these multiple predicted values. The representative value may be appropriately selected from the mean, mode, median, or the like.

The manufacturing lead time prediction model D2 can predict, for a product, the manufacturing time of each of the processes P1, P2, and P3, as well as the dwell time between the processes P1 and P2 and the dwell time between the processes P2 and P3. The sum of the manufacturing time of the respective processes P1, P2, and P3 and the dwell time between the processes P1 and P2 and between the processes P2 and P3 constitutes manufacturing lead time. On the other hand, the sum of the manufacturing time of the respective processes P2 and P3 and the dwell time between the processes P2 and P3 corresponds to time required from the start of the process P2 to completion. Therefore, by using the manufacturing lead time prediction model D2, it is also possible to determine the predicted time until completion of the product. In other words, because the manufacturing lead time prediction model D2 is divided into the manufacturing time prediction model D21 and the dwell time prediction model D22, it becomes possible to predict the time for any desired interval.

In determining the manufacturing lead time or the time for any desired interval, it is permissible to add the representative values of the manufacturing time prediction model D21 and the dwell time prediction model D22, or to obtain the distribution of the manufacturing lead time or the time for any desired interval from the manufacturing time prediction model D21 and the dwell time prediction model D22 and use a representative value of this distribution.

The manufacturing planning program D3 is executed by the arithmetic circuit 45 and causes the arithmetic circuit 45 to make a determination regarding modifications to the manufacturing plan.

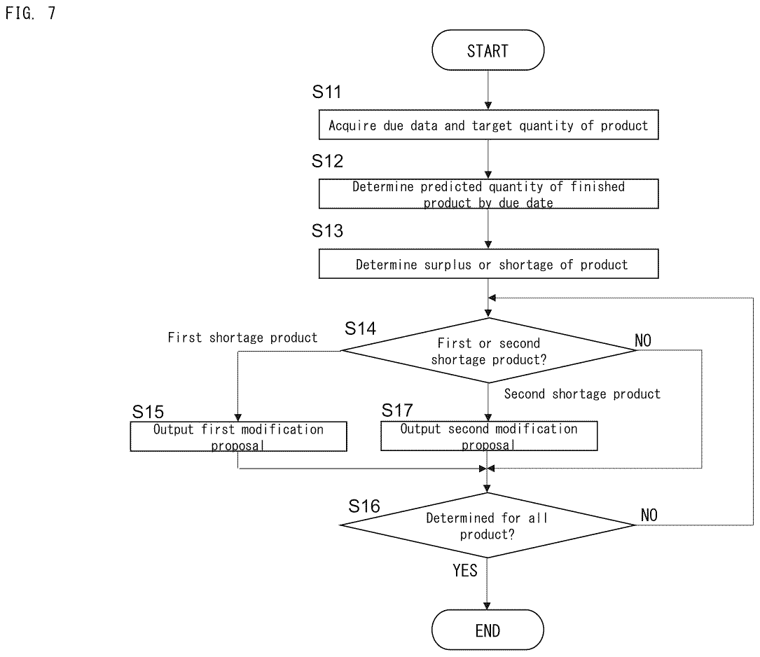

FIG. 7 is a flowchart of the determination of modifications to the manufacturing plan by the manufacturing planning system 4.

The arithmetic circuit 45 acquires the due date and the target quantity of the product (S11). More specifically, the arithmetic circuit 45 accesses the order database DB1 of the information management system 3 and acquires the due date and the target quantity for the product that needs to be manufactured. For example, referring to TABLE 3, for the product with the product number B, the due date is 3/15 and the target quantity is 12,000.

The arithmetic circuit 45 determines the predicted quantity of the finished product by the due date for a plurality of different products based on the manufacturing plan D1 (S12). The predicted quantity of the finished product by the due date is given by the sum of: the quantity of the finished product already obtained; a predicted quantity of the finished product by the due date based on the quantity of the raw material for the first process; and a predicted quantity of the finished product by the due date based on the quantity of the work-in-process product in one or more processes other than the first process among the plurality of processes.

The quantity of the finished product already obtained is obtained from the result database DB21. For example, referring to TABLE 4, for the product with the product number B, as of 3/9, the quantity of the finished product is 3,405.

The predicted quantity of the finished product by the due date based on the quantity of the work-in-process product in one or more processes other than the first process among the plurality of processes is determined from the number of lots of the work-in-process product that will complete manufacturing by the due date. In other words, by multiplying the number of lots of the work-in-process product that will complete manufacturing by the due date by the quantity of the product per lot, the predicted quantity of the finished product based on the work-in-process product can be obtained.

In determining the number of lots of the work-in-process product that will complete manufacturing by the due date, the completion time is predicted for each lot of the work-in-process product. The completion time is time at which the finished product is obtained and corresponds to the end time of the last process among the plurality of processes. The manufacturing lead time prediction model D2 is used for predicting the completion time. By using the manufacturing lead time prediction model D2, the distribution of time for any desired interval can be obtained, and therefore, based on the progress of each lot of the work-in-process product—such as the final state and the time of the final state—the distribution of the end time of the last process (that is, the completion time) can be obtained. For example, for lot number 100 in TABLE 5, the process has advanced to the process P3, the final state is the start of the process P3, and the time of the final state is the start time of the process P3 (3/8 17:21). Therefore, from the manufacturing lead time prediction model D2, the distribution of the manufacturing time of the process P3 for lot number 100 is obtained, and by adding it to the start time of the process P3, the distribution of the completion time is obtained. TABLE 8 below shows an example of the obtained distribution of the completion time for the product number B for lot numbers 100 and onward in TABLE 5. In TABLE 8, Samples 1-3000 are the indices of predicted values sampled from the distribution of the completion time for each lot number. The number of completed lots is the total number of lots for which the completion time is earlier than the due date in each sample; that is, the number of lots of the work-in-process product that will complete manufacturing by the due date. The distribution of the number of completed lots across Samples 1-3000 represents the distribution of the predicted quantity of the finished product based on the work-in-process products. The number of samples is not limited to 3000 and may be 1000, 5000, 10000, or the like, and may be set as appropriate.

TABLE 8

| | | Time of | | | | |
|---|---|---|---|---|---|---|
| Lot | Final | Final | Sample | Sample | | Sample |
| Number | State | State | 1 | 2 | . . . | 3000 |
| 100 | Process | 3/8 | 3/9 | 3/9 | . . . | 3/9 |
| | P3 | 17:21 | 3:31 | 5:53 | | 1:15 |
| | Start | | | | | |
| 105 | Process | 3/9 | 3/11 | 3/11 | . . . | 3/11 |
| | P2 | 16:25 | 16:25 | 18:05 | | 17:15 |
| | Start | | | | | |
| . . . | . . . | . . . | . . . | . . . | . . . | . . . |
| Number of | | | 90 | 86 | . . . | 105 |
| Completed | | | | | | |
| lots | | | | | | |

The predicted quantity of the finished product by the due date based on the quantity of the raw material for the first process is the predicted quantity of the finished product according to the input plan. The predicted quantity of the finished product according to the input plan is determined from the number of lots in the input plan that will complete manufacturing by the due date. In other words, by multiplying the number of lots in the input plan that will complete manufacturing by the due date by the quantity of the product per lot, the predicted quantity of the finished product based on the input plan is obtained.

In determining the number of lots in the input plan that will complete manufacturing by the due date, the completion time is predicted for each lot in the input plan. Based on the input plan, the scheduled manufacturing start time (that is, the scheduled start time of the first process) for beginning the manufacturing of the product corresponding to each lot is determined. TABLE 9 below shows an example of the scheduled manufacturing start time for each lot.

TABLE 9

| | | | | Scheduled |
|---|---|---|---|---|
| Lot | Production | Manufacturing | Manufacturing | Manufacturing |
| Number | Number | Condition 1 | Condition 2 | Start Time |
| 500 | A | x1 | y1 | 3/10 |
| | | | | 9:00 |
| 501 | B | x1 | y2 | 3/10 |
| | | | | 9:00 |
| . . . | . . . | . . . | . . . | . . . |
| 510 | B | x1 | y2 | 3/11 |
| | | | | 9:00 |
| . . . | . . . | . . . | . . . | . . . |
| 600 | M | x9 | y4 | 3/20 |
| | | | | 13:00 |
| . . . | . . . | . . . | . . . | . . . |
| 845 | B | x1 | y2 | 3/29 |
| | | | | 9:00 |

The manufacturing lead time prediction model D2 is used for predicting the completion time. By using the manufacturing lead time prediction model D2, the distribution of the manufacturing lead time is obtained, and therefore, based on the scheduled manufacturing start time, the distribution of the end time of the last process (that is, the completion time) is obtained. TABLE 10 below shows an example of the distribution of the completion time for the product with the product number B obtained based on the input plan. In TABLE 10, Samples 1-3000 are the indices of predicted values sampled from the distribution of the completion time for each lot number. The number of completed lots is the total number of lots in each sample for which the completion time is earlier than the due date. Accordingly, for the product with the product number B, the distribution of the predicted quantity of the finished product based on the input plan is obtained from the number of completed lots across Samples 1-3000.

TABLE 10

| | Scheduled | | | | |
|---|---|---|---|---|---|
| Lot | Manufacturing | Sample | Sample | | Sample |
| Number | Start Time | 1 | 2 | . . . | 3000 |
| 502 | 3/10 | 3/12 | 3/12 | . . . | 3/12 |
| | 9:00 | 1:20 | 2:50 | | 0:15 |
| 510 | 3/11 | 3/13 | 3/13 | . . . | 3/13 |
| | 9:00 | 2:25 | 2:05 | | 3:15 |
| . . . | . . . | . . . | . . . | . . . | . . . |
| 845 | 3/29 | 3/31 | 3/31 | . . . | 3/31 |
| | 9:00 | 1:30 | 3:00 | | 0:20 |
| Number of | | 50 | 42 | . . . | 33 |
| Completed | | | | | |
| lots | | | | | |

In this manner, by using the manufacturing lead time prediction model D2, the distribution of the predicted quantity of the finished product based on the work-in-process product and the distribution of the predicted quantity of the finished product based on the input plan can be obtained. Therefore, the arithmetic circuit 45 determines the distribution of the predicted quantity of the finished product by the due date from the sum of the current quantity of the finished product, the distribution of the predicted quantity of the finished product based on the work-in-process product, and the distribution of the predicted quantity of the finished product based on the input plan. Note that the current quantity of the finished product is not a distribution but a single value.

TABLE 11 below shows the distribution of the predicted quantity of the finished product by the due date for the product with the product number B. In TABLE 11, the predicted quantities were determined assuming that the quantity per lot for the product with the product number B is 60.

TABLE 11

| | Sample | Sample | | Sample |
|---|---|---|---|---|
| | 1 | 2 | . . . | 3000 |
| Current Quantity of Finished | 3,405 | 3,405 | . . . | 3,405 |
| Product | | | | |
| Predicted Quantity of Finished | 90 | 86 | . . . | 105 |
| Product based on Work-in- | | | | |
| process Product | | | | |
| Predicted Quantity of Finished | 50 | 42 | . . . | 33 |
| Product based on Input Plan | | | | |
| Total (Predicted Quantity of | 11,805 | 11,085 | . . . | 11,685 |
| Finished Products by Due Date) | | | | |

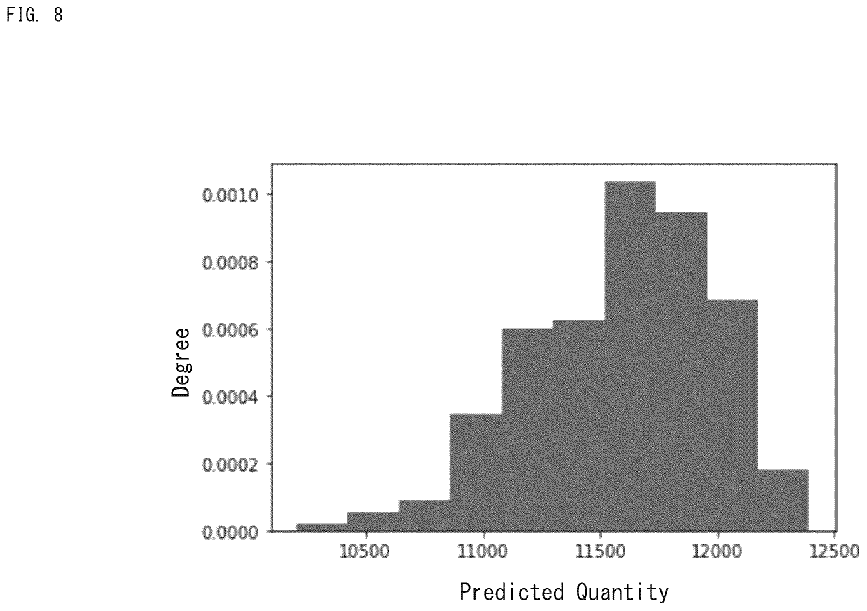

FIG. 8 is an example of a histogram showing the distribution of the predicted quantity of the finished product by the due date for the product with the product number B. From FIG. 8, it is understood that the predicted quantities are distributed in a range from approximately 10,000 to approximately 12,400, with the highest frequency occurring at approximately 11,600.

the arithmetic circuit 45 determines the distribution of the predicted quantity of the finished product by the due date for each product.

Referring again to FIG. 7, the arithmetic circuit 45 next determines whether there is a surplus or shortage of the product (S13). In determining the surplus or shortage of the product, the predicted quantity of the finished product by the due date is compared with the target quantity. In the present embodiment, because the distribution of the predicted quantity of the finished product by the due date is determined, the distribution of the difference between the predicted quantity of the finished product by the due date and the target quantity is used to determine the surplus or shortage of the product.

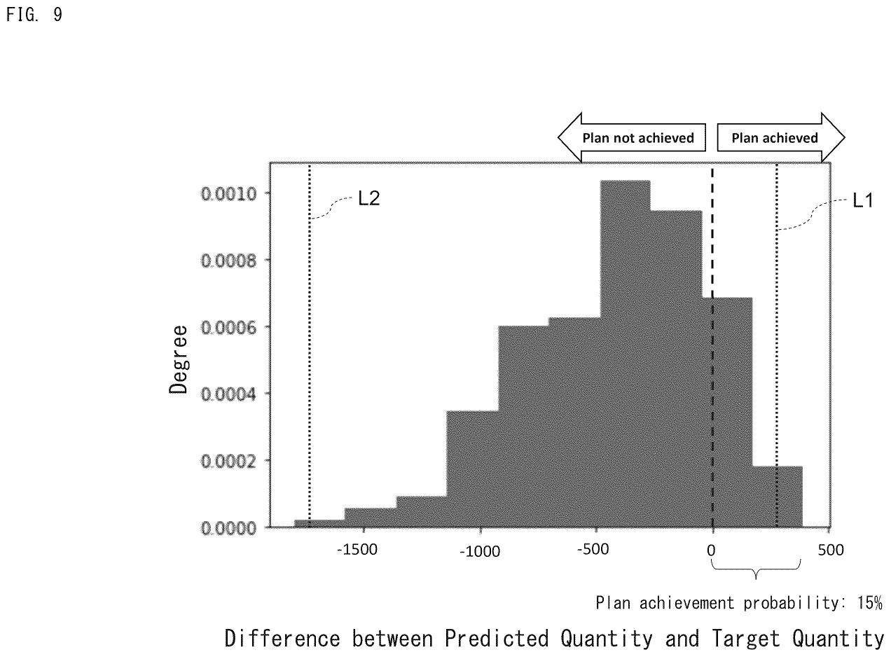

FIG. 9 is an example of a histogram showing the distribution of the difference between the predicted quantity of the finished product by the due date and the target quantity for the product with the product number B. The difference between the predicted quantity and the target quantity is positive when the predicted quantity is greater than the target quantity, and negative when the predicted quantity is less than the target quantity. In FIG. 9, the target quantity is 12,000. In the histogram, the area where the difference between the predicted quantity and the target quantity is greater than or equal to 0 represents the probability that the predicted quantity will be equal to or greater than the target quantity, that is, the probability of being able to prepare the required quantity of the product by the due date (the plan achievement probability). In FIG. 9, the plan achievement probability is approximately 15%. The area where the difference between the predicted quantity and the target quantity is less than 0 represents the probability that the predicted quantity will be less than the target quantity, that is, the probability of not being able to prepare the required quantity of the product by the due date.

Accordingly, if the difference L1 between the predicted quantity and the target quantity corresponding to an upper-side probability equal to a first value in the distribution of the difference is L1<0, it is determined that there will be a shortage of the product by the due date. The difference L1 between the predicted quantity and the target quantity corresponding to the upper-side probability equal to the first value is used as the shortage quantity. The first value may be, for example, 1%, but is not particularly limited and may be 2.5%, 5%, or the like, and may be set as appropriate. Conversely, if the difference L2 between the predicted quantity and the target quantity corresponding to a lower-side probability equal to a second value in the distribution of the difference is L2>0, it is determined that there will be a surplus of the product by the due date. The difference L2 between the predicted quantity and the target quantity corresponding to a lower-side probability equal to the second value is used as the surplus quantity. The second value may be, for example, 1%, but is not particularly limited and may be 2.5%, 5%, or the like, and may be set as appropriate.

In the distribution of the difference between the predicted quantity and the target quantity in FIGS. 9, L1>0 and L2<0, and therefore, it is determined that the product will be neither insufficient nor excessive by the due date. In this case, there is no surplus or shortage, and the predicted quantity may be regarded as equal to the target quantity.

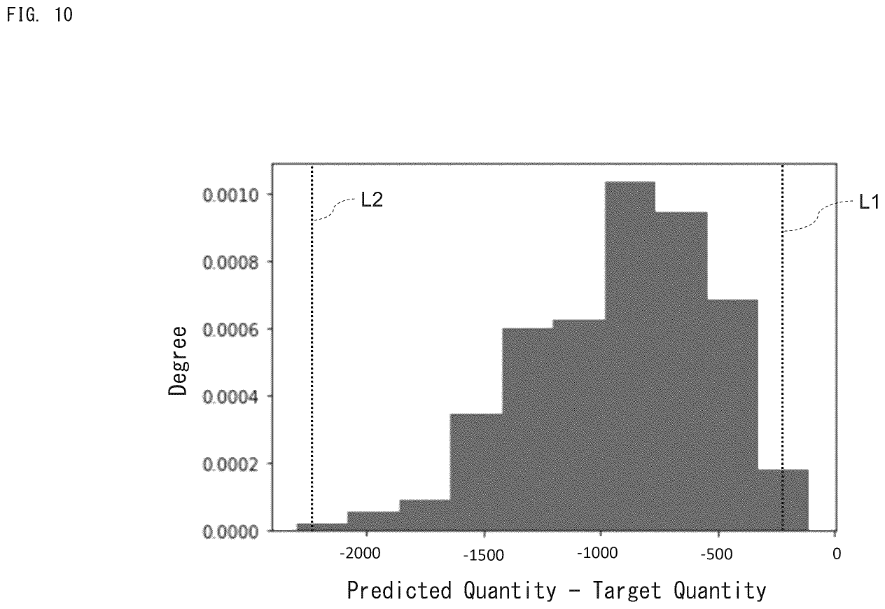

FIG. 10 is another example of a histogram illustrating the distribution of the difference between the predicted quantity of the finished product by the due date and the target quantity for the product with the product number B. In FIG. 10, the target quantity is 12,500 instead of 12,000. In the distribution of the difference between the predicted quantity and the target quantity in FIG. 10, since L1<0, it is determined that the product will be insufficient by the due date. The absolute value of L1 is used as the shortage quantity. In this case, the predicted quantity may be given by the target quantity-L1.

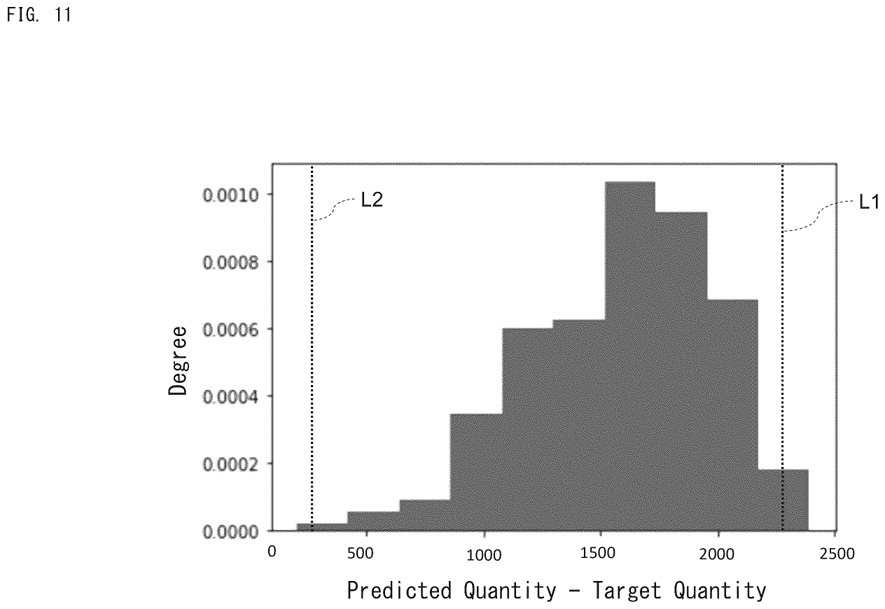

FIG. 11 is a histogram showing yet another example of the distribution of the difference between the predicted quantity and the target quantity of the finished product. In FIG. 11, the target quantity is 10,000 instead of 12,000. In the distribution of the differences between the predicted quantity and the target quantity in FIG. 11, since L2>0, it is determined that the product will be excessive by the due date. The absolute value of L2 is used as the surplus quantity. In this case, the predicted quantity may be given by the target quantity+L2.

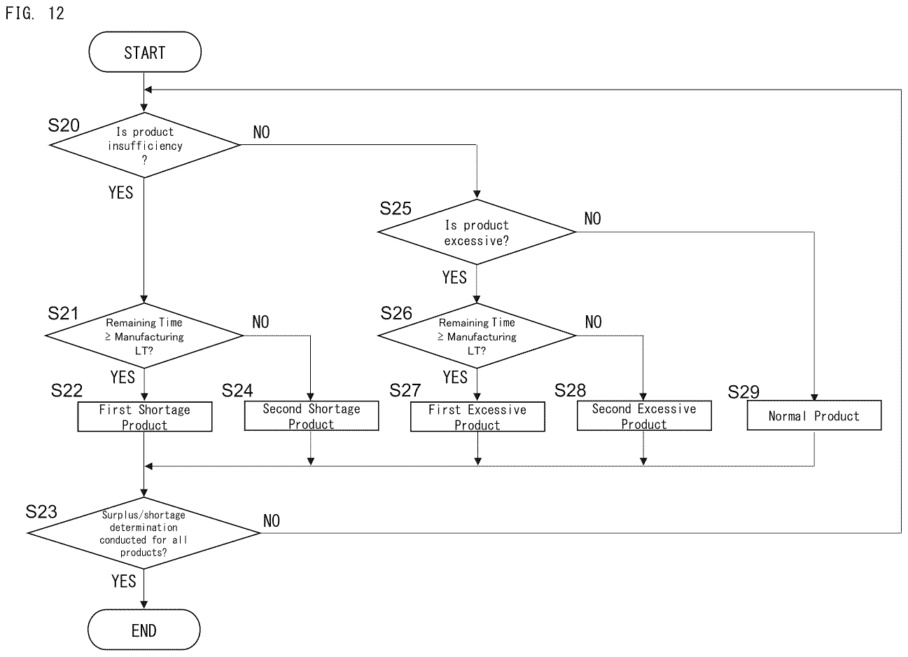

Referring again to FIG. 7, the arithmetic circuit 45 next determines the surplus or shortage of the product (S13). FIG. 12 is a flowchart illustrating surplus/shortage determination of the product.

The arithmetic circuit 45 determines whether there will be a shortage of the product by the due date (S20). When L1<0 in the distribution of the difference between the predicted quantity of the finished product by the due date and the target quantity for the product, it is determined that the product will be insufficient by the due date.

When it is determined in step S20 that the product will be insufficient by the due date (S20: YES), the product is classified as a shortage product. Further, it is determined whether the remaining time until the due date is equal to or longer than the manufacturing lead time (denoted as “manufacturing LT” in FIG. 12) (S21).

When, in step S21, the remaining time until the due date is equal to or longer than the manufacturing lead time (S21: YES), the product is classified as a first shortage product (S22). The first shortage product is a shortage product among the plurality of different products for which the predicted quantity of the finished product by the due date is less than the target quantity and for which the remaining time until the due date is equal to or longer than the manufacturing lead time. Thereafter, it is determined whether the surplus/shortage determination has been completed for all products that need to be manufactured by the due date (S23).

In step S23, when it is determined that the surplus/shortage determination has been completed for all products that need to be manufactured by the due date (S23: YES), the processing ends; otherwise (S23: NO), step S20 is executed for the next product.

When, in step S21, the remaining time until the due date is shorter than the manufacturing lead time (S21: NO), the product is classified as a second shortage product (S24). The second shortage product is a shortage product among the plurality of different products for which the predicted quantity of the finished product by the due date is less than the target quantity and for which the remaining time until the due date is shorter than the manufacturing lead time. Thereafter, the process proceeds to step S23.

When it is determined in step S20 that the product will not be insufficient by the due date (S20: NO), it is then determined whether the product will be excessive by the due date (S25). When L2>0 in the distribution of the difference between the predicted quantity of the finished product by the due date and the target quantity for the product, it is determined that the product will be excessive by the due date.

When, in step S25, it is determined that the product will be excessive by the due date (S25: YES), the product is classified as an excessive product. Further, it is determined whether the remaining time until the due date is equal to or longer than the manufacturing lead time (S26).

When, in step S26, the remaining time until the due date is equal to or longer than the manufacturing lead time (S26: YES), the product is classified as a first excessive product (S27). The first excessive product is an excessive product among the plurality of different products for which the predicted quantity of the finished product by the due date exceeds the target quantity and for which the remaining time until the due date is equal to or longer than the manufacturing lead time. Thereafter, the process proceeds to step S23.

When, in step S26, the remaining time until the due date is shorter than the manufacturing lead time (S26: NO), the product is classified as a second excessive product (S28). The second excessive product is an excessive product among the plurality of different products for which the predicted quantity of the finished product by the due date exceeds the target quantity and for which the remaining time until the due date is shorter than the manufacturing lead time. Thereafter, the process proceeds to step S23.

When, in step S25, it is determined that the product will not be excessive by the due date (S25: NO), the product is classified as a normal product. Thereafter, the process proceeds to step S23.

In this manner, the products that need to be manufactured by the due date are classified into first shortage products, second shortage products, first excessive products, second excessive products, and normal products, based on the surplus/shortage determination.

The first shortage products and the second shortage products are shortage products for which the predicted quantity of the finished product by the due date is less than the target quantity. For the first shortage products, the remaining time until the due date is equal to or longer than the manufacturing lead time. Therefore, by increasing the quantity of the first shortage product manufactured in the first process that is performed first among the plurality of processes, it is expected that the shortage quantity of the product by the due date can be reduced. For the second shortage products, the remaining time until the due date is shorter than the manufacturing lead time. Therefore, increasing the quantity of the second shortage product manufactured in the first process is not expected to reduce the shortage quantity of the product by the due date. For the second shortage products, by prioritizing the manufacturing of the second shortage product in the second process, which is executed after the first process among the plurality of processes, the manufacturing of the product in progress (work-in-process product) can be prioritized and completed, thereby making it possible to reduce the shortage quantity of the product by the due date.

The first excessive products and the second excessive products are excessive products for which the predicted quantity of the finished product by the due date exceeds the target quantity. When the manufacturing of the shortage product is to be prioritized, it is preferable to postpone the manufacturing of the excessive product. For the first excessive products, the remaining time until the due date is equal to or longer than the manufacturing lead time, whereas for second excessive products, the remaining time until the due date is shorter than the manufacturing lead time. Therefore, the first excessive products have a higher likelihood than the second excessive products of being able to secure the target quantity by the due date even if their input into the first apparatus is postponed. For the second excessive products, even if their input into the first apparatus is postponed, it is desirable to monitor the predicted quantity of the finished product by the due date to ensure that the target quantity can be secured. Therefore, the first excessive products are selected with higher priority than the second excessive products. In the present embodiment, a first excessive product is a candidate to have its manufacturing postponed relative to shortage products in at least one of the first process or the second process. A second excessive product is a candidate to have its manufacturing postponed relative to shortage products in the second process.

TABLE 12 below shows an example of the results of the surplus/shortage determination for the products. In TABLE 12, a positive surplus/shortage value indicates a surplus quantity, and a negative surplus/shortage value indicates a shortage quantity.

TABLE 12

| Production | Target | Predicted | Surplus/Shortage | Remaining Time ≥ | |
|---|---|---|---|---|---|
| Number | Quantity | Quantity | Value | Manufacturing LT | Classification |
| A | 5,000 | 6,000 | 1,000 | No | Second |
| | | | | | Excessive |
| | | | | | Product |
| B | 12,000 | 11,000 | −1,000 | No | Second |
| | | | | | Shortage |
| | | | | | Product |
| C | 9,000 | 9,000 | 0 | — | Normal |
| | | | | | Product |
| D | 9,000 | 10,000 | 1,000 | Yes | First |
| | | | | | Excessive |
| | | | | | Product |
| E | 8,000 | 7,000 | −1,000 | Yes | First |
| | | | | | Shortage |
| | | | | | Product |
| . . . | . . . | . . . | . . . | . . . | . . . |

In this manner, the arithmetic circuit 45 detects a shortage product (first shortage product or second shortage product) from among the plurality of different products, based on a comparison between the predicted quantity and the target quantity for each of the plurality of different products.

Referring again to FIG. 7, the arithmetic circuit 45 next determines whether the product is the shortage product, that is, whether the product is the first shortage product or the second shortage product (S14).

In step S14, when the product is the first shortage product (S14: first shortage product), a first modification proposal is generated and output (S15).

The first modification proposal changes the manufacturing plan so as to increase the quantity of the shortage product (first shortage product) manufactured in the first process, which is the first to be executed among the multiple processes. The manufacturing facility 2 includes one or more first apparatuses (the apparatuses 21-1 to 21-4) that perform the first process. The manufacturing plan includes an input plan indicating the scheduled manufacturing of the plurality of different products in the one or more first apparatuses. Therefore, the quantity of the product manufactured in the first process is determined by the input plan. Accordingly, the first modification proposal changes the input plan so as to increase the production quantity of the first shortage product. In the present embodiment, the first modification proposal includes increasing the number of lots of the first shortage product in the input plan by a predetermined number. The predetermined number is determined based on the quantity per lot of the first shortage product and the difference between the predicted quantity and the target quantity (shortage quantity) for the first shortage product.

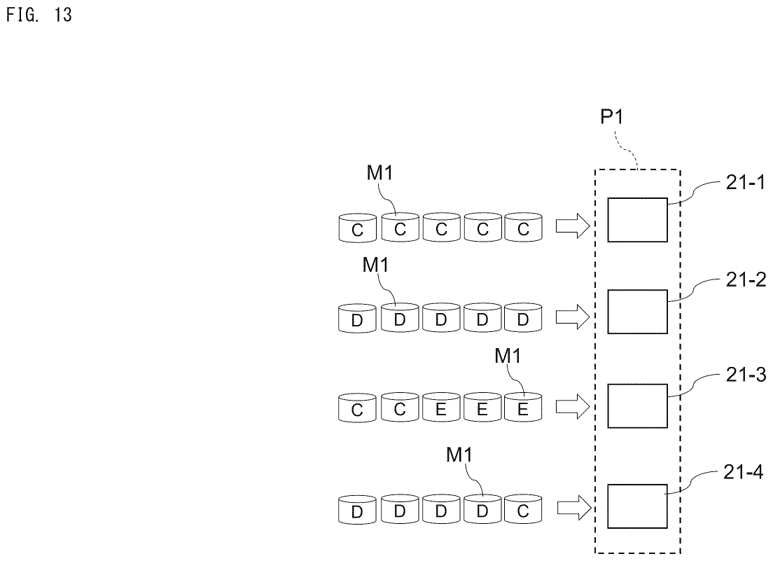

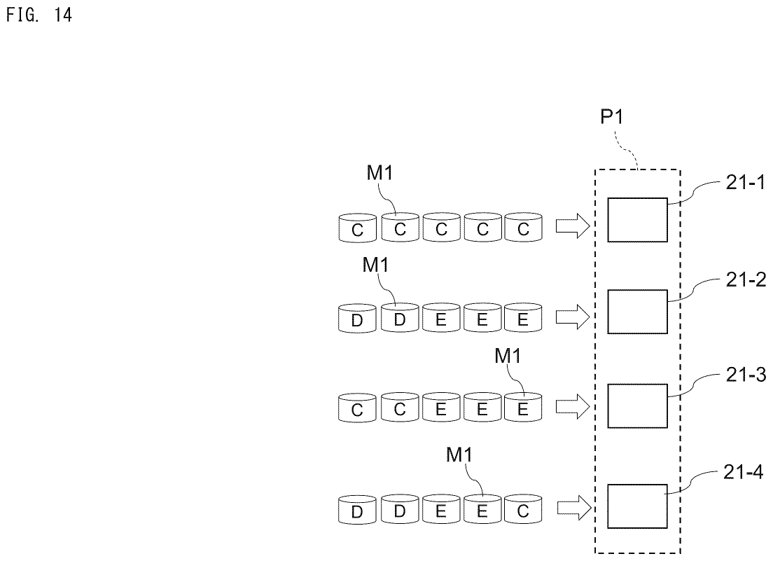

FIG. 13 and FIG. 14 are explanatory diagrams of the first modification proposal. In particular, FIG. 13 is a schematic diagram of the input plan before the first modification proposal is applied, and FIG. 14 is a schematic diagram of the input plan after the first modification proposal is applied.

FIG. 13 shows, in units of lots, the raw materials M1 of products with the product numbers C, D, and E that are to be input into the apparatuses 21-1, 21-2, 21-3, and 21-4, which perform the process P1 that is the first process. In FIG. 13, five lots of the raw material M1 for the product number C are sequentially input one lot at a time into the apparatus 21-1. Five lots of the raw material M1 for the product number D are sequentially input one lot at a time into the apparatus 21-2. In the apparatus 21-3, three lots of the raw material M1 for the product number E are sequentially input one lot at a time, followed by two lots of the raw material M1 for the product number C input sequentially one lot at a time. In the apparatus 21-4, one lot of the raw material M1 for the product number C is input, followed by four lots of the raw material M1 for the product number D sequentially input one lot at a time.

In TABLE 12, the product with the product number E is a first shortage product. Therefore, the first modification proposal changes the input plan so as to increase the number of lots of the product with the product number E by a predetermined number. The predetermined number is determined based on the quantity of the shortage product per lot and the difference between the predicted quantity and the target quantity (the shortage quantity) for the shortage product. In TABLE 12, the shortage quantity for the product with the product number E is 1,000. If the quantity per lot of the product with the product number E is 200, then the predetermined number becomes five.

In increasing the production quantity of the first shortage product, the first modification proposal replaces a lot of the excessive product with a lot of the first shortage product. The excessive product is selected from the first excessive products. In TABLE 12, the product with the product number D is the first excessive product. Therefore, as shown in FIG. 14, the first modification proposal replaces five lots of the product with the product number D with five lots of the product with the product number E.

Outputting the first modification proposal includes transmitting or sending data of the first modification proposal to the information terminal 5 via the communication device 43. This allows the information terminal 5 to present the first modification proposal to the user 6. The user 6 may modify the manufacturing plan according to the first modification proposal. By adopting the first modification proposal, the manufacturing of the first shortage product is prioritized, thereby enabling a reduction in the shortage quantity by the due date.

Referring again to FIG. 7, after step S15, it is determined whether the determination of whether each product that needs to be manufactured by the due date is a shortage product has been completed (S16).

In step S16, when it is determined that the determination as to whether each product that needs to be manufactured by the due date is a shortage product has been completed (S16: YES), the processing ends; otherwise (S16: NO), step S14 is executed for the next product.

In step S14, when the product is the second shortage product (S14: second shortage product), a second modification proposal is generated and output (S17).

The second modification proposal changes the manufacturing plan so as to prioritize the manufacturing of the shortage product (second shortage product) in the second process, which is executed after the first process among the plurality of processes. The production quantity of the product in the second process is determined by the queue of the second apparatus that performs the second process. Therefore, the second modification proposal adds a lot of the second shortage product to the head of the queue of the second apparatus so that the second shortage product is preferentially manufactured in the second apparatus.

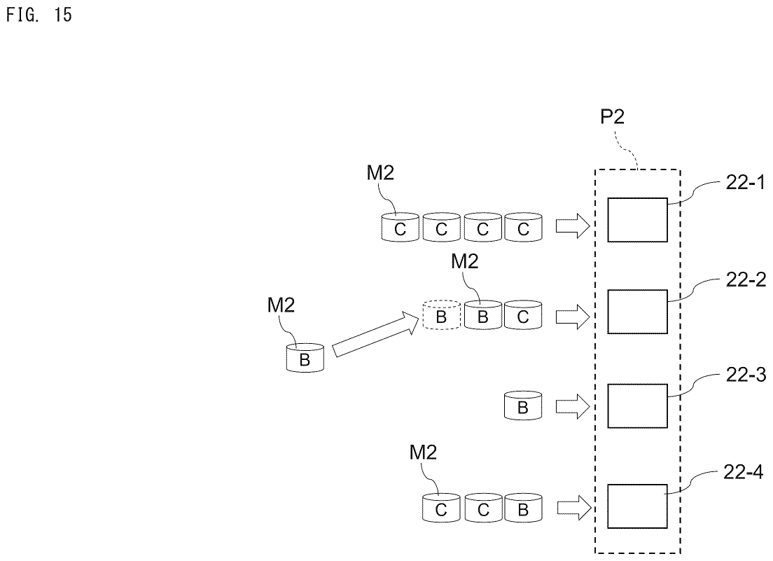

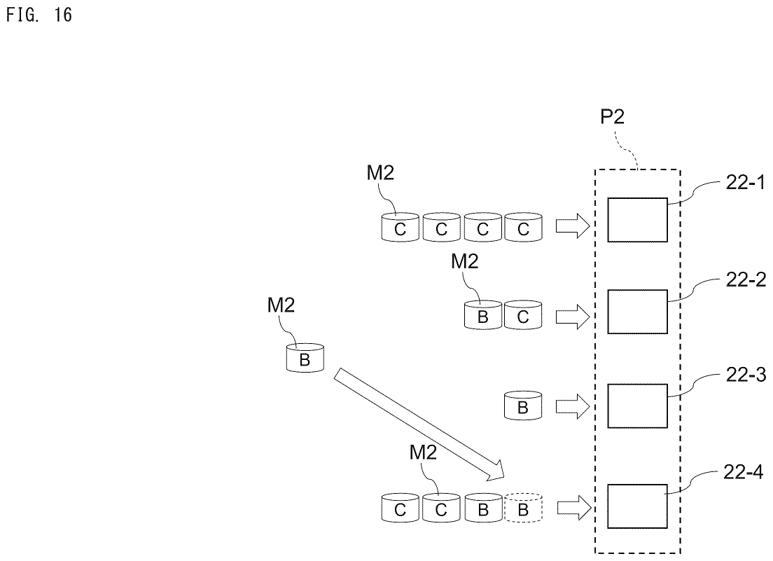

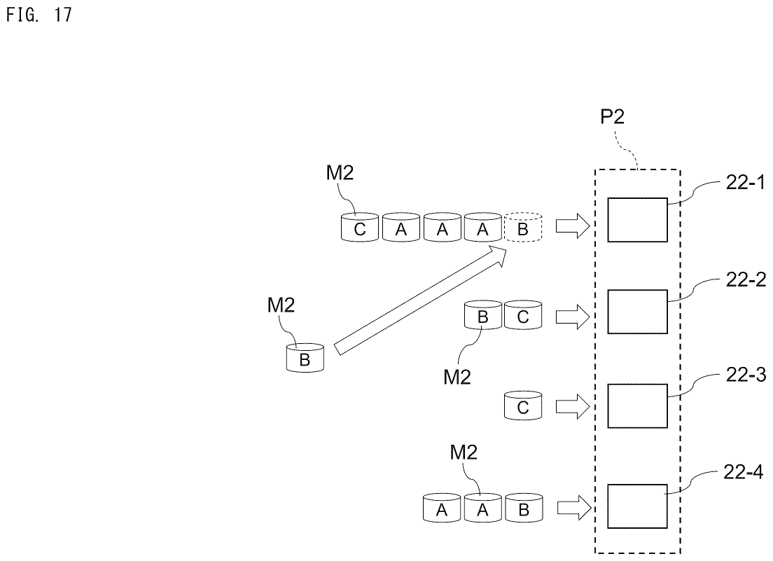

FIG. 15, FIG. 16, and FIG. 17 are explanatory diagrams of the second modification proposal. In particular, FIG. 15 is a schematic diagram of the queue before the second modification proposal is applied, and FIG. 16 and FIG. 17 are schematic diagrams of the queue after the second modification proposal is applied.

FIG. 15 shows the queues of the apparatuses 22-1, 22-2, 22-3, and 22-4, which execute the process P2 being the second process. In FIG. 15, the queue of the apparatus 22-1 contains four lots of the work-in-process product M2 for the product number C. The queue of the apparatus 22-2 contains one lot of the work-in-process product M2 for the product number C and one lot of the work-in-process product M2 for the product number B, arranged in this order. The queue of the apparatus 22-3 contains one lot of the work-in-process product M2 for the product number B. The queue of the apparatus 22-4 contains one lot of the work-in-process product M2 for the product number B and two lots of the work-in-process product M2 for the product number C, arranged in this order.

Normally, because the rule is first-in first-out, the work-in-process product M2 is added to the end of the queue of one of the apparatuses 22-1 to 22-4. In FIG. 15, the work-in-process product M2 for the product number B is added to the end of the queue of the apparatus 22-2 in accordance with the first-in first-out rule.

In TABLE 12, the product with the product number B is the second shortage product. Therefore, in the second modification proposal, the work-in-process product M2 for the product number B is added not to the end of one of the queues of the apparatuses 22-1 to 22-4, but to the head of one of these queues. In FIG. 16, the work-in-process product M2 for the product number B is added to the head of the queue of the apparatus 22-4.

Here, it is preferable for the second modification proposal to add the lot of the second shortage product to the head of a queue among the queues of the apparatuses 22-1 to 22-4 that contains a lot of a product different from the second shortage product among the plurality of different products. In particular, it is preferable for the second modification proposal to add the lot of the second shortage product to the head of a queue among the queues of the apparatuses 22-1 to 22-4 that contains a lot of the excessive product. The excessive product is selected from the first excessive product or the second excessive product. The first excessive product is selected with higher priority than the second excessive product.

In FIG. 17, the queue of the apparatus 22-1 contains three lots of the work-in-process product M2 for the product number A and one lot of the work-in-process product M2 for the product number C, arranged in this order. The queue of the apparatus 22-4 contains one lot of the work-in-process product M2 for the product number B and two lots of the work-in-process product M2 for the product number A, arranged in this order. Therefore, it is preferable that the work-in-process product M2 for the product number B be added to the head of one of the queues of the apparatuses 22-1, 22-2, and 22-4 among the queues of the apparatuses 22-1 to 22-4. In TABLE 12, the product number A is the second excessive product. Therefore, the queues of the apparatuses 22-1 and 22-4 contain the excessive products. Accordingly, it is preferable that the work-in-process product M2 for the product number B be added to the head of one of the queues of the apparatuses 22-1 and 22-4. Here, when a plurality of queues contain lots of the excessive products, it is preferable that the second modification proposal add the lot of the second shortage product to the head of the queue among the plurality of queues that contains the largest total number of lots of the excessive products. The number of lots of the excessive products in the queue of the apparatus 22-1 is three, and the number of lots of the excessive products in the queue of the apparatus 22-4 is two. Therefore, it is preferable that the work-in-process product M2 for the product number B be added to the head of the queue of the apparatus 22-1.

Outputting the second modification proposal includes transmitting or sending data of the second modification proposal to the information terminal 5 via the communication device 43. This allows the information terminal 5 to present the second modification proposal to the user 6. The user 6 may modify the manufacturing plan according to the second modification proposal. By adopting the second modification proposal, the manufacturing of the second shortage product is prioritized, thereby enabling a reduction in the shortage quantity by the due date.

Referring again to FIG. 7, after step S17, the process proceeds to step S16.

In step S14, when the product is neither the first shortage product nor the second shortage product (S14: NO), the process proceeds to step S16.

In this manner, for the product with the product number E, the manufacturing planning system 4 proposes changing the manufacturing plan to increase the input of the raw material M1 (first modification proposal), because the predicted quantity is highly likely to fall short of the target quantity but the remaining time until the due date is equal to or longer than the manufacturing lead time. For the product with the product number B, the manufacturing planning system 4 outputs proposing (second modification proposal) to accelerate the manufacturing of the work-in-process products M2 and M3, because the predicted quantity is highly likely to fall short of the target quantity and the remaining time until the due date is shorter than the manufacturing lead time. For the products with the product numbers A and D, the manufacturing planning system 4 designates them as candidates to have their manufacturing postponed relative to the products with the product numbers B and E, because the predicted quantity is highly likely to exceed the target quantity. In particular, for the product with the product number D, the remaining time until the due date is equal to or longer than the manufacturing lead time, whereas for the product with the product number A, the remaining time until the due date is shorter than the manufacturing lead time. Therefore, the manufacturing of the product with the product number D is postponed relative to the manufacturing of the product with the product number A. In this manner, based on a comparison between the predicted quantity and the target quantity and a comparison between the remaining time and the manufacturing lead time, the manufacturing planning system 4 determines the manufacturing priority of the plurality of different products.

### 1.2 Evaluation

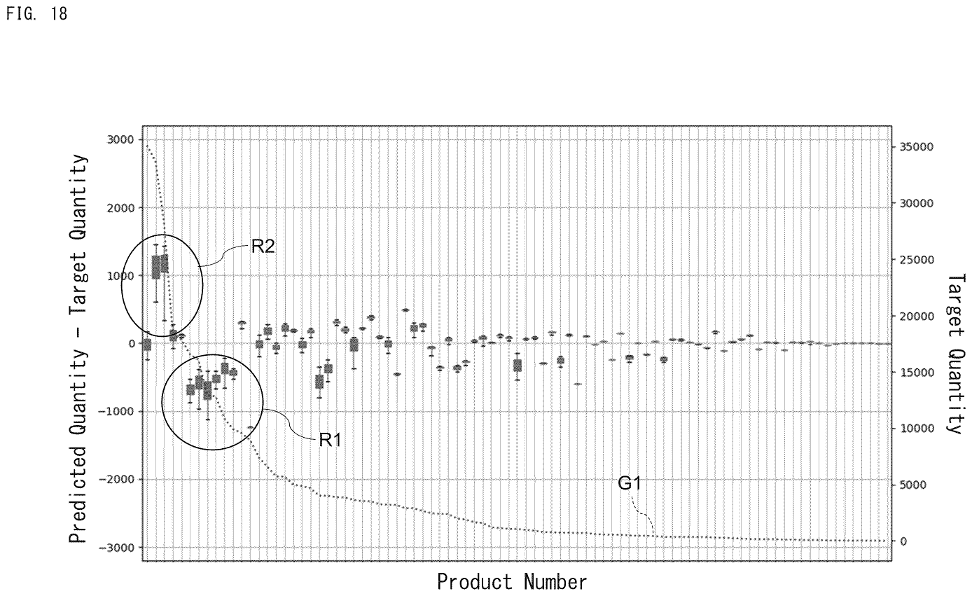

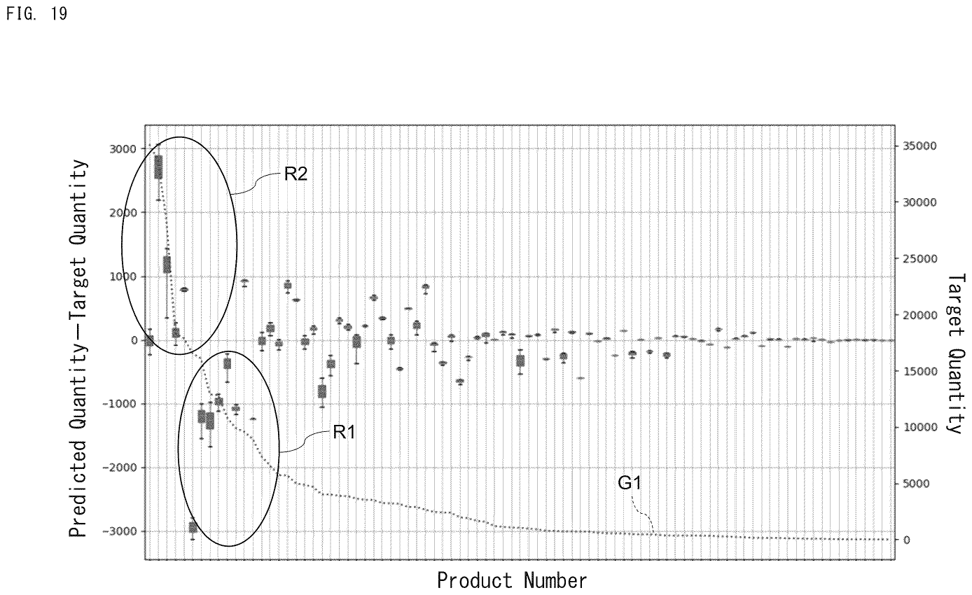

To confirm the effectiveness of the first modification proposal for the manufacturing plan generated by the manufacturing planning system 4 as described above, a simulation was conducted. FIG. 18 is a graph showing the difference between the predicted quantity and the target quantity for each product when the first modification proposal is implemented. FIG. 19 is a graph showing the difference between the predicted quantity and the target quantity for each product when the first modification proposal is not implemented. In FIGS. 18 and 19, the horizontal axis represents the product number, the right vertical axis represents the target quantity, and the left vertical axis represents the difference between the predicted quantity and the target quantity (predicted quantity-target quantity).

In FIGS. 18 and 19, G1 is a graph showing the target quantity of the product, and it is understood that the larger the target quantity, the greater the tendency for the difference between the predicted quantity and the target quantity to increase. For the product number included in the range enclosed by R1, the predicted quantity is significantly smaller than the target quantity, and the production quantity is considered relatively likely to be insufficient. For the product number included in the range enclosed by R2, the predicted quantity is significantly larger than the target quantity, and the production quantity is considered relatively likely to be excessive. Comparing FIG. 18, in which the first modification proposal is implemented, with FIG. 19, in which the first modification proposal is not implemented, it was confirmed that FIG. 18 tends to show smaller differences between the predicted quantity and the target quantity for product numbers included in both R1 and R2.

From the above, it was confirmed that implementing the first modification proposal makes it possible to reduce the shortage quantity of the product by the due date. It was also confirmed that, by prioritizing insufficient products over excessive products, it is possible to reduce the excessive quantities of products by the due date.

To confirm the effectiveness of the second modification proposal in the manufacturing plan generated by the manufacturing planning system 4 as described above, a simulation was conducted. In the verification experiment, the quantity of each product was evaluated for a case where the plurality of different products were manufactured within a relatively short period when the second modification proposal was implemented, and for a case where the plurality of different products were manufactured within a relatively short period when the second modification proposal was not implemented.

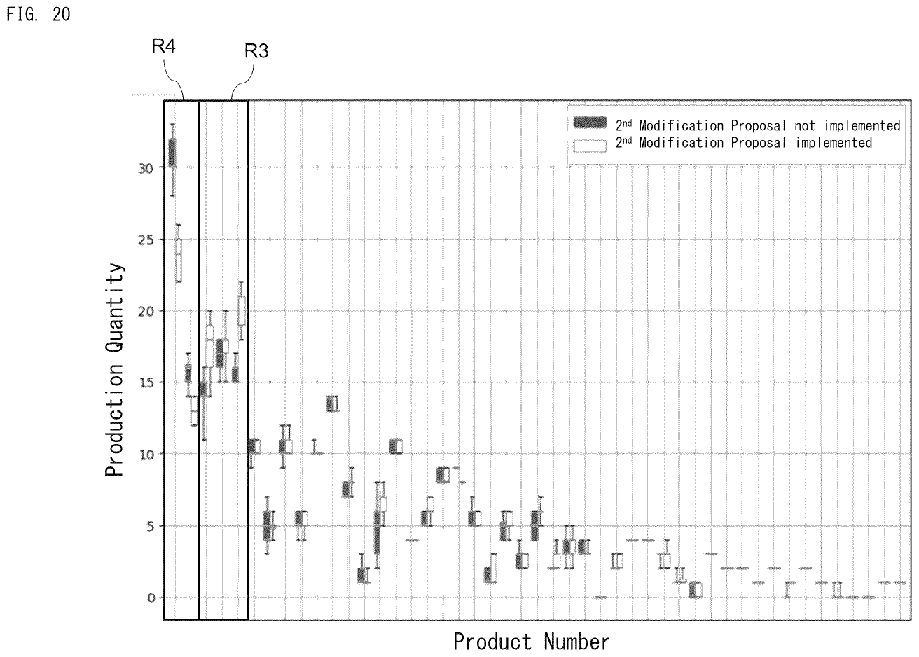

FIG. 20 is a graph comparing the production quantity of each product within a short period (e.g., three days) within the lead time, under the conditions of implementing and not implementing the second modification proposal. In FIG. 20, the production quantity when the modification proposal was not implemented and the production quantity when the modification proposal was implemented are shown as pairs of filled and unfilled boxes, respectively. The products with the product numbers included in the range enclosed by R3 are shortage products, and the products with the product numbers included in the range enclosed by R4 are excessive products. From FIG. 20, it was confirmed that implementing the second modification proposal increases the production quantities of the shortage products within the short period within the lead time and decreases the production quantities of the excessive products.

From the above, it was confirmed that implementing the second modification proposal makes it possible to reduce the shortage quantity of the product by the due date. It was also confirmed that, by prioritizing shortage products over excessive products, it is possible to reduce the excessive quantity of the product by the due date.

In this manner, the manufacturing planning system 4 makes it possible to reduce shortages and excesses of products. For example, by applying a certain margin to the target quantity, products can be manufactured without shortages or excesses. This enables the reduction of unnecessary product inventory and the reduction of product manufacturing lead time.

### 1.3 Advantageous Effects

The aforementioned manufacturing panning system 4 includes the arithmetic circuit 45 accessible to data on the manufacturing plan D1 for manufacturing a plurality of different products by the manufacturing facility 2 performing a plurality of processes. The arithmetic circuit 45 is configured to: for a shortage product among the plurality of different products of which a predicted quantity of a finished product by a due date is less than a target quantity, output, a first modification proposal to change the manufacturing plan D1 so as to increase a production quantity of the shortage product in a first process that is performed first among the plurality of processes when remaining time until the due date is equal to or longer than manufacturing lead time; and output, a second modification proposal to change the manufacturing plan D1 so as to prioritize manufacturing the shortage product in a second process that is performed after the first process among the plurality of processes. This configuration enables reduction in a shortage quantity of a product at a due date.

In the manufacturing planning system 4, the manufacturing facility 2 includes one or more first apparatuses (apparatuses 21-1 to 21-4) that perform the first process (process P1). The manufacturing plan D1 includes an input plan indicating a schedule for manufacturing the plurality of different products by the one or more first apparatuses. The first modification proposal includes increasing, by a predetermined number, a number of lots of the shortage product in the input plan. This configuration enables reduction in a shortage quantity of a product at a due date.

In the manufacturing planning system 4, the predetermined number is determined based on a quantity per lot of the shortage product and a difference between the predicted quantity and the target quantity of the shortage product. This configuration enables a further reduction in the shortage quantity of the product at the due date. In the manufacturing planning system 4, the first modification proposal includes replacing a lot of an excessive product with the lot of the shortage product in the input plan. The excessive product is a product that is among the plurality of different products and of which the predicted quantity exceeds the target quantity. This configuration makes it possible to reduce the shortage and excess quantities of products by the due date.

In the manufacturing planning system 4, the manufacturing facility 2 includes one or more second apparatuses (apparatuses 22-1 to 22-4, 23-1, 23-2) that perform the second process (process P2, P3). The manufacturing plan D1 includes queues for the one or more second apparatuses. The second modification proposal includes adding a lot of the shortage product to a head of the queues of the one or more second apparatuses. This configuration makes it possible to reduce the shortage and excess quantities of products by the due date.

In the manufacturing planning system 4, the second modification proposal includes adding the lot of the shortage product to a head of a queue that is among the one or more queues of the second apparatuses and includes a lot of a product that is among the plurality of different products and is different from the shortage product. This configuration makes it possible to reduce the shortage and excess quantities of products by the due date.

In the manufacturing planning system 4, the second modification proposal includes adding a lot of the shortage product to a head of a queue that is among the queues of the one or more second apparatuses and includes a lot of an excessive product. The excessive product is a product that is among the plurality of different products and of which the predicted quantity exceeds the target quantity. This configuration makes it possible to reduce the shortage and excess quantities of products by the due date.

In the manufacturing planning system 4, when there are a plurality of queues including lots of the excessive product, the second modification proposal includes adding the lot of the shortage product to a head of a queue that is among the plurality of queues and has a largest total number of lots of the excessive product. This configuration not only makes it possible to reduce the shortage and excess quantities of the product by the due date, but also prevents delays in the manufacturing of the normal product that was originally being manufactured smoothly, which could otherwise occur when the shortage product is prioritized.

In the manufacturing planning system 4, the arithmetic circuit 45 is configured to detect the shortage product from among the plurality of different products based on a comparison between the predicted quantity and the target quantity of each of the plurality of different products. This configuration allows the user to avoid the effort of specifying the shortage product from among the plurality of different products.

In the manufacturing planning system 4, the arithmetic circuit 45 is configured to determine the predicted quantity for each of the plurality of different products based on the manufacturing plan. The predicted quantity is given by a sum of: a quantity of the finished product already obtained, a predicted quantity of the finished product by the due date based on quantities of raw materials in the first process, and a predicted quantity of the finished product by the due date based on a quantity of a work-in-process product in one or more processes other than the first process among the plurality of processes. This configuration allows the user to avoid the effort of determining the predicted quantities of the plurality of different products.

In the manufacturing planning system 4, the arithmetic circuit 45 is configured to determine the manufacturing lead time of the shortage product using the manufacturing lead time prediction model D2. The manufacturing lead time prediction model D2 includes the manufacturing time prediction model D21 configured to determine manufacturing time for each of the plurality of processes, and the dwell time prediction model D22 configured to determine dwell time between each pair of the plurality of processes. The manufacturing lead time of the shortage product is determined based on manufacturing time output from the manufacturing time prediction model D21 and dwell time output from the dwell time prediction model D22 for the shortage product. This configuration improves the accuracy of selecting whether to apply the first modification proposal or the second modification proposal, thereby enabling a further reduction in the shortage quantity of the product by the due date.

In the manufacturing planning system 4, the arithmetic circuit 45 is configured to select, as a candidate to postpone manufacturing relative to the shortage product in at least one of the first process or the second process, an excessive product that is among the plurality of different products and of which the predicted quantity exceeds the target quantity, when the period is equal to or longer than the manufacturing lead time. This configuration makes it possible to reduce the shortage and excess quantities of products by the due date.

In the manufacturing planning system 4, the arithmetic circuit 45 is configured to select, as a candidate to postpone manufacturing relative to the shortage product in the second process, an excessive product that is among the plurality of different products and of which the predicted quantity exceeds the target quantity, when the period is shorter than the manufacturing lead time. This configuration makes it possible to reduce the shortage and excess quantities of products by the due date.

The aforementioned manufacturing panning system 4 is considered to implement or perform the following method (manufacturing planning method). The manufacturing planning method is performed by the arithmetic circuit 45 accessible to data on the manufacturing plan D1 for manufacturing a plurality of different products by the manufacturing facility 2 performing a plurality of processes, and includes: for a shortage product among the plurality of different products of which a predicted quantity of a finished product by a due date is less than a target quantity, outputting, a first modification proposal to change the manufacturing plan D1 so as to increase a production quantity of the shortage product in a first process that is performed first among the plurality of processes when remaining time until the due date is equal to or longer than manufacturing lead time; and outputting, a second modification proposal to change the manufacturing plan D1 so as to prioritize manufacturing the shortage product in a second process that is performed after the first process among the plurality of processes.

The manufacturing planning method performed by the manufacturing planning system 4 can be implemented by the arithmetic circuit 45 performing the manufacturing planning program D3. The manufacturing planning program D3 is a program for enabling the manufacturing planning method to be performed by the arithmetic circuit. This configuration enables reduction in a shortage quantity of a product at a due date.

### 2. Variations

Embodiments of the present disclosure are not limited to the embodiment described above. The above embodiment may be variously modified in accordance with design and other factors, provided that the objects of the present disclosure can be achieved. Hereinafter, variations of the above embodiment will be enumerated. The variations described below may be applied in appropriate combinations.

In one variation, the manufacturing facility 2 is not limited to the configuration of FIG. 2. The content and number of the processes executed in the manufacturing facility 2 are not particularly limited and may be set as appropriate according to the product. The number of apparatuses for each process in the manufacturing facility 2 is also not particularly limited and may be set as appropriate according to the scale or other characteristics of the manufacturing facility 2.

In one variation, instead of outputting the first modification proposal or the second modification proposal to the information terminal 5, the arithmetic circuit 45 may output it to the manufacturing facility 2 and automatically reflect modifications to the manufacturing plan D1 in the manufacturing of products at the manufacturing facility 2.

In one variation, the second process may be any one or more of two or more processes executed after the first process among the plurality of processes, and it is not necessary to use all of the two or more processes as the second process.

In one variation, the manufacturing lead time prediction model D2 does not necessarily need to include both the manufacturing time prediction model D21 and the dwell time prediction model D22, and may include only one of them. The manufacturing lead time does not necessarily have to be determined from the manufacturing time and the dwell time, and the manufacturing lead time prediction model D2 may be constructed as a model that uses the manufacturing lead time as the dependent variable and product information as explanatory variables.

In one variation, the method for constructing the manufacturing time prediction model D21 is not limited to the embodiment described above. As a method for constructing the manufacturing time prediction model D21, various conventionally known prediction model construction methods, such as determining the mean and variance by linear regression, may be used. In the above embodiment, the assumed distribution for the manufacturing time is not limited to a normal distribution and may be determined in accordance with actual data.

In one variation, the method for constructing the dwell time prediction model D22 is not limited to the embodiment described above. As a method for constructing the dwell time prediction model D22, various conventionally known prediction model construction methods, such as determining the weight coefficients W_{α} and W_{β} using the Newton method, may be used. In the above embodiment, the assumed distribution for the dwell time is not limited to a gamma distribution and may be determined in accordance with actual data.

In one variation, the manufacturing lead time prediction model D2 may be constructed using a trained model.

In one variation, the manufacturing lead time prediction model D2 is not essential. For example, the manufacturing lead time of each product may be extracted from a database indicating the manufacturing lead time of each product.

In one variation, the arithmetic circuit 45 does not necessarily need to determine the distribution of the predicted quantity of a product. Nor does the arithmetic circuit 45 necessarily need to determine the predicted quantity of a product. The arithmetic circuit 45 may obtain the predicted quantity of a product from an external device via communication or the like.

In one variation, the arithmetic circuit 45 does not necessarily need to detect a shortage product from among the plurality of different products. The arithmetic circuit 45 may obtain information identifying a shortage product from an external device via communication or the like.

In one variation, the first modification proposal does not necessarily need to replace a lot of the excessive product with a lot of the shortage product in the input plan. When the shortage quantity of the shortage product is greater than the excessive quantity of a single excessive product, the first modification proposal may replace lots of multiple types of excessive products with a lot of the shortage product. Alternatively, the first modification proposal may simply add a lot of the shortage product to the input plan.

In one variation, the second modification proposal may include adding a lot of the shortage product to the head of the queue of one or more of the second apparatuses, selecting the queue that results in the fewest number of product changeovers when the lot of the shortage product is added to the head. In this regard, FIG. 17 is referenced. In FIG. 17, suppose that the apparatus 22-1 is currently manufacturing the work-in-process product M2 for the product number A. In this case, if the work-in-process product M2 for the product number B, which is a lot of the shortage product, is added to the head of the queue of the apparatus 22-1, it becomes necessary to switch the configuration of the apparatus 22-1 from the product number A to the product number B. After manufacturing the work-in-process product M2 for the product number B, it becomes necessary to switch the configuration of the apparatus 22-1 back from the product number B to the product number A. Such an increase in configuration changeovers may lead to reduced manufacturing efficiency. From this viewpoint, if the apparatus 22-4 in FIG. 17 is currently manufacturing the work-in-process product M2 for the product number B, then adding the lot of the work-in-process product M2 for the product number B to the head of the queue of the apparatus 22-4, rather than the apparatus 22-1, may be considered. In this case, configuration changeover associated with adding the lot of the shortage product becomes unnecessary, which can be expected to improve manufacturing efficiency. It is preferable that the selection of the queue to which the lot of the shortage product is added take into account the number of configuration changeovers of the second apparatuses.

In one variation, the plurality of processes may include two or more processes performed after the first process. In the embodiment described above, the processes P2 and P3 are performed after the process P1 that is the first process. Here, depending on the remaining time, even if the manufacturing of the shortage product is prioritized in the process P2 as the second process, the shortage product may still not be completed by the due date. In such a case, the process P3, which is performed after the process P2, may be selected as the second process to prioritize the manufacturing of the shortage product. Accordingly, the second modification proposal includes selecting, as the second process, a process that is performed later among two or more processes performed after the first process, with the likelihood of selecting a later-executed process increasing as the remaining time becomes shorter. More preferably, the second modification proposal includes selecting, as the second process, from two or more processes performed after the first process among the plurality of processes, a process in which time required from start of the process to completion of the shortage product is equal to or less than the remaining time. The time from the start of the process until the completion of the shortage product may be calculated using the manufacturing lead time prediction model D2. This enables a further reduction in the shortage quantity of the product by the due date.

In one variation, the manufacturing planning system 4 may be implemented by a computer system including multiple servers or the like. It is not essential that the multiple functions (components) of the manufacturing planning system 4 be housed within a single housing, and the components of the manufacturing planning system 4 may be distributed across multiple housings. Furthermore, at least some of the functions of the manufacturing planning system 4, such as part of the functions of the arithmetic circuit 45, may be implemented by cloud computing or the like.

### 3. Aspects

As apparent from the above embodiment and variations, the present disclosure includes the following aspects.

### [Aspect 1]

A manufacturing panning system comprising an arithmetic circuit accessible to data on a manufacturing plan for manufacturing a plurality of different products by a manufacturing facility performing a plurality of processes,
the arithmetic circuit being configured to:
for a shortage product among the plurality of different products of which a predicted quantity of a finished product by a due date is less than a target quantity,
output, a first modification proposal to change the manufacturing plan so as to increase a production quantity of the shortage product in a first process that is performed first among the plurality of processes when remaining time until the due date is equal to or longer than manufacturing lead time; and
output, a second modification proposal to change the manufacturing plan so as to prioritize manufacturing the shortage product at a second process that is performed after the first process among the plurality of processes.

### [Aspect 2]

The manufacturing panning system of aspect 1, wherein:
the manufacturing facility includes one or more first apparatuses that perform the first process;
the manufacturing plan includes an input plan indicating a schedule for manufacturing the plurality of different products by the one or more first apparatuses; and
the first modification proposal includes increasing, by a predetermined number, a number of lots of the shortage product in the input plan.

### [Aspect 3]

The manufacturing panning system of aspect 2, wherein the predetermined number is determined based on a quantity per lot of the shortage product and a difference between the predicted quantity and the target quantity of the shortage product.

### [Aspect 4]

The manufacturing panning system of aspect 2 or 3, wherein:
the first modification proposal includes replacing a lot of an excessive product with the lot of the shortage product in the input plan; and
the excessive product is a product that is among the plurality of different products and of which the predicted quantity exceeds the target quantity.

### [Aspect 5]

The manufacturing panning system of any one of aspects 1 to 4, wherein:
the manufacturing facility includes one or more second apparatuses that perform the second process;
the manufacturing plan includes queues for the one or more second apparatuses; and
the second modification proposal includes adding a lot of the shortage product to a head of the queues of the one or more second apparatuses.

### [Aspect 6]

The manufacturing panning system of aspect 5, wherein the second modification proposal includes adding the lot of the shortage product to a head of a queue that is among the one or more queues of the second apparatuses and includes a lot of a product that is among the plurality of different products and is different from the shortage product.

### [Aspect 7]

The manufacturing panning system of aspect 5 or 6, wherein:
the second modification proposal includes adding a lot of the shortage product to a head of a queue that is among the queues of the one or more second apparatuses and includes a lot of an excessive product; and
the excessive product is a product that is among the plurality of different products and of which the predicted quantity exceeds the target quantity.

### [Aspect 8]

The manufacturing panning system of aspect 7, wherein, when there are a plurality of queues including lots of the excessive product, the second modification proposal includes adding the lot of the shortage product to a head of a queue that is among the plurality of queues and has a largest total number of lots of the excessive product.

### [Aspect 9]

The manufacturing panning system of any one of aspects 1 to 8, wherein the arithmetic circuit is configured to detect the shortage product from among the plurality of different products based on a comparison between the predicted quantity and the target quantity of each of the plurality of different products.

### [Aspect 10]

The manufacturing panning system of aspect 9, wherein:
the arithmetic circuit is configured to determine the predicted quantity for each of the plurality of different products based on the manufacturing plan; and
the predicted quantity is given by a sum of: a quantity of the finished product already obtained, a predicted quantity of the finished product by the due date based on quantities of raw materials in the first process, and a predicted quantity of the finished product by the due date based on a quantity of a work-in-process product in one or more processes other than the first process among the plurality of processes.

### [Aspect 11]

The manufacturing panning system of any one of aspects 1 to 10, wherein
the arithmetic circuit is configured to determine the manufacturing lead time of the shortage product using a manufacturing lead time prediction model;
the manufacturing lead time prediction model includes a manufacturing time prediction model configured to determine manufacturing time for each of the plurality of processes, and a dwell time prediction model configured to determine dwell time between each pair of the plurality of processes; and
the manufacturing lead time of the shortage product is determined based on manufacturing time output from the manufacturing time prediction model and dwell time output from the dwell time prediction model for the shortage product.

### [Aspect 12]

The manufacturing panning system of any one of aspects 1 to 11, wherein the arithmetic circuit is configured to select, as a candidate to postpone manufacturing relative to the shortage product in at least one of the first process or the second process, an excessive product that is among the plurality of different products and of which the predicted quantity exceeds the target quantity, when the period is equal to or longer than the manufacturing lead time.

### [Aspect 13]

The manufacturing panning system of any one of aspects 1 to 12, wherein the arithmetic circuit is configured to select, as a candidate to postpone manufacturing relative to the shortage product in the second process, an excessive product that is among the plurality of different products and of which the predicted quantity exceeds the target quantity, when the period is shorter than the manufacturing lead time.

### [Aspect 14]

The manufacturing panning system of any one of aspects 1 to 13, wherein the second modification proposal includes selecting, as the second process, from two or more processes performed after the first process among the plurality of processes, a process in which time required from start of the process to completion of the shortage product is equal to or less than the remaining time.

### [Aspect 15]

A manufacturing panning method performed by an arithmetic circuit accessible to data on a manufacturing plan for manufacturing a plurality of different products by a manufacturing facility performing a plurality of processes, comprising: for a shortage product that is among the plurality of different products and of which a predicted quantity of a finished product on a due date is less than a target quantity,
outputting, a first modification proposal to change the manufacturing plan so as to increase a production quantity of the shortage product at a first process that is performed first among the plurality of processes when remaining time until the due date is equal to or longer than manufacturing lead time; and
outputting, a second modification proposal to change the manufacturing plan so as to prioritize manufacturing the shortage product at a second process that is performed after the first process among the plurality of processes.

### [Aspect 16]

A program for enabling the manufacturing planning method of aspect 15 to be performed by the arithmetic circuit.

Aspects 2 to 14 are optional and not essential. Aspects 2 to 14 can be combined with Aspect 15 appropriately.

### INDUSTRIAL APPLICABILITY

The present disclosure is applicable to manufacturing planning systems, manufacturing planning methods, and programs. In particular, the present disclosure is applicable to a manufacturing planning system, a manufacturing planning method, and a program for manufacturing a plurality of different products by a manufacturing facility performing a plurality of processes.

### REFERENCE SIGNS LIST

2 Manufacturing Facility
20 Apparatus
21-1 to 21-4 Apparatus (First Apparatus)
22-1 to 22-4 Apparatus (Second Apparatus)
23-1, 23-2 Apparatus (Second Apparatus)
4 Manufacturing Planning System
45 Arithmetic Circuit
D1 Manufacturing Plan
D2 Manufacturing Lead Time Prediction Model
D21 Manufacturing Time Prediction Model
D22 Dwell Time Prediction Model

1. A manufacturing panning system comprising an arithmetic circuit accessible to data on a manufacturing plan for manufacturing a plurality of different products by a manufacturing facility performing a plurality of processes,
the arithmetic circuit being configured to:
for a shortage product among the plurality of different products of which a predicted quantity of a finished product by a due date is less than a target quantity,
output, a first modification proposal to change the manufacturing plan so as to increase a production quantity of the shortage product in a first process that is performed first among the plurality of processes when remaining time until the due date is equal to or longer than manufacturing lead time; and
output, a second modification proposal to change the manufacturing plan so as to prioritize manufacturing the shortage product in a second process that is performed after the first process among the plurality of processes.

2. The manufacturing panning system of claim 1, wherein:
the manufacturing facility includes one or more first apparatuses that perform the first process;
the manufacturing plan includes an input plan indicating a schedule for manufacturing the plurality of different products by the one or more first apparatuses; and
the first modification proposal includes increasing, by a predetermined number, a number of lots of the shortage product in the input plan.

3. The manufacturing panning system of claim 2, wherein the predetermined number is determined based on a quantity per lot of the shortage product and a difference between the predicted quantity and the target quantity of the shortage product.

4. The manufacturing panning system of claim 2, wherein:
the first modification proposal includes replacing a lot of an excessive product with the lot of the shortage product in the input plan; and
the excessive product is a product that is among the plurality of different products and of which the predicted quantity exceeds the target quantity.

5. The manufacturing panning system of claim 1, wherein:
the manufacturing facility includes one or more second apparatuses that perform the second process;
the manufacturing plan includes queues for the one or more second apparatuses; and
the second modification proposal includes adding a lot of the shortage product to a head of the queues of the one or more second apparatuses.

6. The manufacturing panning system of claim 5, wherein the second modification proposal includes adding the lot of the shortage product to a head of a queue that is among the one or more queues of the second apparatuses and includes a lot of a product that is among the plurality of different products and is different from the shortage product.

7. The manufacturing panning system of claim 5, wherein:
the second modification proposal includes adding a lot of the shortage product to a head of a queue that is among the queues of the one or more second apparatuses and includes a lot of an excessive product; and
the excessive product is a product that is among the plurality of different products and of which the predicted quantity exceeds the target quantity.

8. The manufacturing panning system of claim 7, wherein, when there are a plurality of queues including lots of the excessive product, the second modification proposal includes adding the lot of the shortage product to a head of a queue that is among the plurality of queues and has a largest total number of lots of the excessive product.

9. The manufacturing panning system of claim 1, wherein the arithmetic circuit is configured to detect the shortage product from among the plurality of different products based on a comparison between the predicted quantity and the target quantity of each of the plurality of different products.

10. The manufacturing panning system of claim 9, wherein:
the arithmetic circuit is configured to determine the predicted quantity for each of the plurality of different products based on the manufacturing plan; and
the predicted quantity is given by a sum of: a quantity of the finished product already obtained, a predicted quantity of the finished product by the due date based on quantities of raw materials in the first process, and a predicted quantity of the finished product by the due date based on a quantity of a work-in-process product in one or more processes other than the first process among the plurality of processes.

11. The manufacturing panning system of claim 1, wherein
the arithmetic circuit is configured to determine the manufacturing lead time of the shortage product using a manufacturing lead time prediction model;
the manufacturing lead time prediction model includes a manufacturing time prediction model configured to determine manufacturing time for each of the plurality of processes, and a dwell time prediction model configured to determine dwell time between each pair of the plurality of processes; and
the manufacturing lead time of the shortage product is determined based on manufacturing time output from the manufacturing time prediction model and dwell time output from the dwell time prediction model for the shortage product.

12. The manufacturing panning system of claim 1, wherein the arithmetic circuit is configured to select, as a candidate to postpone manufacturing relative to the shortage product in at least one of the first process or the second process, an excessive product that is among the plurality of different products and of which the predicted quantity exceeds the target quantity, when the period is equal to or longer than the manufacturing lead time.

13. The manufacturing panning system of claim 1, wherein the arithmetic circuit is configured to select, as a candidate to postpone manufacturing relative to the shortage product in the second process, an excessive product that is among the plurality of different products and of which the predicted quantity exceeds the target quantity, when the period is shorter than the manufacturing lead time.

14. The manufacturing panning system of claim 1, wherein the second modification proposal includes selecting, as the second process, from two or more processes performed after the first process among the plurality of processes, a process in which time required from start of the process to completion of the shortage product is equal to or less than the remaining time.

15. A manufacturing panning method performed by an arithmetic circuit accessible to data on a manufacturing plan for manufacturing a plurality of different products by a manufacturing facility performing a plurality of processes, comprising: for a shortage product that is among the plurality of different products and of which a predicted quantity of a finished product by a due date is less than a target quantity,
outputting, a first modification proposal to change the manufacturing plan so as to increase a production quantity of the shortage product in a first process that is performed first among the plurality of processes when remaining time until the due date is equal to or longer than manufacturing lead time; and
outputting, a second modification proposal to change the manufacturing plan so as to prioritize manufacturing the shortage product in a second process that is performed after the first process among the plurality of processes.

16. A non-transitory storage medium storing a program for enabling the manufacturing planning method of claim 15 to be performed by the arithmetic circuit.
